(19) United States
(12) Patent Application Publication
(10) Pub. No.: US 2010/0057629 A1
(43) Pub. Date: Mar. 4, 2010

(54) Inventive Process Documentation, Management, and Stimulation System

(76) Inventor: Michael Ira Markowitz, Brooklyn, NY (US)

Correspondence Address: ABELMAN, FRAYNE & SCHWAB, 666 THIRD AVENUE, 10TH FLOOR, NEW YORK, NY, 10017, US

(21) Appl. No.: 11/992,493

(22) PCT Filed: Sep. 28, 2006
(86) PCT No.: PCT/US06/38364

§ 371 Date: Mar. 21, 2008

Related U.S. Application Data
(60) Provisional application No. 60/721,507, filed on Sep. 28, 2005.

(51) Int. Cl. G06Q 50/00; G06Q 10/00; G06F 15/16

(52) U.S. Cl. 705/310; 709/206

(57) ABSTRACT

A system for use in an inventive process for at least one invention includes at least one of a conception module that is adapted to receive, process and communicate information associated with conception and reduction to practice of the at least one invention; an exploitation module that is adapted to receive, process and communicate information associated with deciding whether to exploit the at least one invention in a market place; a testing module that is adapted to receive, process and communicate information associated with testing of the at least one invention; and a patent application module that is adapted to receive, process and communicate information associated with preparation, filing and prosecution of the at least one invention. Each of the modules is adapted for installation and operation with one or more computer devices, and further adapted to share particular information associated with the inventive process with at least another one of the modules.

### CROSS REFERENCE TO RELATED APPLICATION

This patent application claims the benefit of U.S. Provisional Application, application No. 60/721,507, filed Sep. 28, 2005, the contents of which are incorporated by reference herein.

### BACKGROUND OF THE INVENTION

1. Field of the Invention

This invention relates to the field of assisting in the inventive process, and more particularly, to documenting, managing and stimulating the process of origination of inventions.

2. Description of the Related Art

The methods presently used to document the inventive process may include the use of such records as disclosure documents and provisional applications filed in the United States Patent and Trademark Office, laboratory notebooks, and other records kept by technical workers. The disclosure documents and provisional applications often are used to prove the conception of an invention, while laboratory notebooks and other records kept by technical workers are used to prove conception, but also record the general progress of the technical workers in their projects, and in attempting to originate inventions. Such technical workers, at the stage of the inventive process until conception, may only be managed in their efforts by their supervisors or superiors in their respective technical or research and development departments. Stimulation of the inventive process at the pre-conception phase may use resources available at the laboratory or other research facility where the technical work is being performed. Such resources may be extremely meager or may include state of the art computer assisted research or extensive library facilities to determine any relevant knowledge in the field of research. There may also be opportunities, ranging from extremely limited to quite diverse and extensive, for the researcher to consult with his or her colleagues to stimulate and assist him or her in the research performed.

The foregoing description of the pre-conception stage of the inventive process assumes that the inventor is working for a business corporation, university, government agency, or other institution pursuing research and development or other inventive activities. If, however, the inventor is self-employed, the arrangements to support this stage of the inventive process may be radically different. Although the individual inventor can, without great difficulty, document the conception of an invention by the previously mentioned methods of a provisional application, a disclosure document, or laboratory notebooks, or other records, there typically is no one to manage and expedite his or her activities except the inventor. Any stimulation that the inventor receives to ease the inventive process must be largely self-generated either through resources available on the internet or otherwise through a computer, a personal technical library, visits to public libraries, or consultation with other workers in the field by personal meetings, telephone or other means of communication, such as e-mail.

Once an invention has been conceived and the conception has been documented, the process of attempting to effectively use the invention to benefit the public and the inventor may begin, assuming that the inventor or organization employing the inventor makes a decision to exploit the invention. If the invention has not been sufficiently tested to prove that it operates for the intended purpose during the pre-conception phase, the invention will typically be made and tested to determine whether the invention can successfully operate. In order for the inventor or organization owning the invention to be protected against the competing sale or use by others of the invention, which would diminish the reward otherwise accruing to the inventor or organization from the successful sale and use of the invention, the inventor or organization may choose to file a patent application in one or many countries if other forms of protection such as trade secret protection are deemed to be insufficient. Inventors or organizations may pursue both the filing of patent application(s) and the construction and testing of an invention, or one or the other in any order.

The decision to exploit the invention may involve a search of the related art to determine whether the invention can be patented, and even if it can be patented, whether or not its use, may involve the infringement of other patents, and thus the need to obtain licenses or other permission from patent owners to successfully exploit the invention. In addition, the decision of whether or not to exploit the invention may be based on commercial or marketing studies to determine whether a product embodying the invention would be sufficiently profitable to justify such exploitation.

Related art searches and commercial or marketing studies may be performed by organizations employing inventors on a regular basis, as part of a standard procedure in their activities, or they may be performed on a selective basis based on business intuition or other subjective factors, or they may not be performed at all, and the decision to exploit or not may be made entirely subjectively or based on general experience, business or otherwise. The related art searches may be performed by the inventors or other technical workers themselves, but due to the legal issues involved, at least the determination of patentability or infringement will be delegated to attorneys employed by the organization or to independent law firms. Individual inventors will either rely on their own related art searches, and request legal opinions regarding patentability and infringement from their attorneys, or rely on their attorneys for both the search and the opinion if they possess the financial resources and inclination to obtain such results. With regard to commercial or marketing studies, such studies undertaken personally by the inventor will normally be informal, unless the inventor possesses professional expertise in this area or has the financial resources to seek the help of a marketing or other firm specializing in this area.

If an initial decision is made to exploit the invention, and making and testing the invention is thought to be necessary to determine the successful operation of the invention, the inventor(s), an organization employing the inventor(s), or some testing company hired by the organization will typically perform such testing. Records will typically be kept of a description of the tested product, the steps involved in the testing, and the results of the testing. If an individual self-employed inventor is involved, the inventor will typically make and test the invention, and keep any records of the testing desired, or, if the inventor possesses sufficient financial resources and the desire, an independent testing firm will be hired to test the invention, and keep any records desired. Of course, in the event of an unsuccessful test, a decision may be made to terminate the inventive process regarding the tested invention, or further work may be deemed necessary to make improvements or other changes.

Regardless of whether or not a physical test of the invention is performed, the inventor, or organization employing the inventor may decide to file a patent application in one or more countries to protect the commercial rights in the invention. The task of preparing and filing a patent application is typically either performed by attorneys employed by the organization employing the inventor or by a law firm independent of the organization or inventor. In the event that an individual self-employed inventor lacks the financial resources or desire to employ an attorney, the inventor may prepare and file the patent application through his or her own efforts. Various drafts of the application while it is in preparation may be kept, as well as copies of correspondence between the inventor or organization and the attorneys, where applicable.

Several conclusions may be drawn from the prior summary of the present inventive process. First, the amount or level of documentation, management, and stimulation of the inventive process may vary greatly, based on the identity of the inventor, organization, or attorneys involved. Second, the quality of documentation, management, and stimulation of the inventive may also vary greatly, again based on the identity of the inventor, organization, or attorneys involved. Third, there appears to be room for improvement in both the quantity and quality of documentation, management, and stimulation of the inventive process.

Improvement in both the quantity and quality of documentation, management, and stimulation of the inventive process could have many benefits.

The process of technological improvement could be eased and accelerated. The amount of such easing and acceleration should depend on how intensive and extensive the improvements made. If improvements were made with regard to individual companies or with regard to individual inventors, a certain improvement in technological progress should appear. Of course, if such improvements were made over entire industries or economies, greater acceleration of technological progress would be expected to result, with the maximum benefit to be expected if such improvements were made worldwide. In addition, to the extent that the results of such improvement can be shared between individual inventors, organizations, economies, or worldwide without otherwise negatively affecting intellectual property rights, such sharing should be expected to further accelerate the rate of technological progress and to aid in the selection of the most promising areas of technology, both socially and technologically, on which to focus research and development resources. Such improved technological progress could have innumerable social and economic benefits.

In addition, either in a legal system where the first to invent obtains a patent or in a legal system where the first to file obtains a patent, improvements in the documentation, management, and stimulation of the inventive process could expedite the process of filing a patent application, and improve the quality of the patent application filed, thus improving the probability of inventors or organizations successfully obtaining economically valuable protection of inventions.

Based on the foregoing considerations, an object of the invention disclosed herein is to organize and improve both the quantity and quality of documentation, management, and stimulation of the inventive process.

A further object of the invention disclosed herein is to encourage the sharing of relevant information arising out of the inventive process to the extent compatible with the undiminished protection of intellectual property rights.

A yet further object of the invention disclosed is to aid in the improvement of both the rate of technological progress and selection of the direction of technological progress.

### SUMMARY OF THE INVENTION

A modular and scalable system for documenting, managing, and stimulating the inventive process is disclosed herein. The system is preferably implemented by software, which can either be downloaded from the internet or other computer network, or may be purchased in physical form from various sellers thereof. The system should preferably run on any commonly available personal computer, and should not require the use of a mainframe, or other large and not commonly available computing facilities.

The modules of the system will preferably comprise a module for dealing with the inventive process up to and including conception, a module for dealing with the decision whether the conceived invention should be exploited, a module for dealing with the making of prototype(s) of the invention and testing the invention, a module for dealing with the filing of one or more patent applications, and a module for storing data created in the other modules which exceeds memory available to the other modules.

The system should preferably be scalable in two senses. First, the purchaser of the system should preferably be able to purchase any module individually, and then add any or all the modules in any order, with no decrease in performance of the individual modules purchased, except for functions dependent on the presence of other modules. Second, the system should provide for communication between copies of the software resident on different computers so that information may be shared, for example, between inventors in a particular company, between inventors in different companies collaborating in a research consortium or other joint research agreement, or between inventors and other parties to the maximum extent compatible with preserving intellectual property rights. The system, however, should preferably prevent unauthorized sharing by appropriate security measures, such as user identifications and passwords, such security measures being applicable, for example, to the entire system or to selected modules thereof.

In one embodiment, a system is provided for use in an inventive process for at least one invention. The system includes at least one of a conception module, an exploitation module, a testing module, and a patent application module. The conception module is adapted to receive, process and communicate information associated with conception and reduction to practice of the at least one invention, the exploitation module is adapted to receive, process and communicate information associated with deciding whether to exploit the at least one invention in a market place, the testing module is adapted to receive, process and communicate information associated with testing of the at least one invention, and the patent application module is adapted to receive, process and communicate information associated with preparation, filing and prosecution of the at least one invention. Each of the modules is adapted for installation and operation with one or more computer devices, and further adapted to share particular information associated with the inventive process with at least another one of the modules.

In another embodiment, the system includes at least one module for use in an inventive process for at least one invention, wherein the at least one module is at least one of a conception module for receiving, processing and communicating information associated with conception and reduction to practice of the at least one invention, an exploitation module for receiving, processing and communicating information associated with deciding whether to exploit the at least one invention in a market place, a testing module for receiving, processing and communicating information associated with testing of the at least one invention, and a patent application module for receiving, processing and communicating information associated with preparation, filing and prosecution of the at least one invention.

In yet another embodiment, a method is provided for use in an inventive process for at least one invention. The method includes the steps of providing at least one computer device having installed thereon at least one of a conception module for receiving, processing and communicating information associated with conception and reduction to practice of the at least one invention, an exploitation module for receiving, processing and communicating information associated with deciding whether to exploit the at least one invention in a market place, a testing module for receiving, processing and communicating information associated with testing of the at least one invention, and a patent application module for receiving, processing and communicating information associated with preparation, filing and prosecution of the at least one invention; and enabling each of the modules to share particular information associated with the inventive process with at least another one of the modules.

### BRIEF DESCRIPTION OF THE DRAWINGS

FIG. 1 is a schematic diagram of the modules of the system, the interfaces of the modules, the interactions between the modules, and the interactions between the modules and the interfaces.

FIGS. 2A-2C show exemplary computer screen interfaces for creating or editing project files.

FIG. 3 shows an exemplary computer screen interface for a project file. FIG. 4 shows an exemplary computer screen interface for entering data in a project file.

FIG. 5 shows an exemplary computer screen interface for an invention file.

FIG. 6 shows an exemplary computer screen interface for the entry of the description of an invention.

FIG. 7 shows an exemplary computer screen interface for the time entry function of the conception module.

FIG. 8 shows an exemplary computer screen interface for the communication function of the conception module.

FIG. 9 shows an exemplary computer screen interface for the search function of the conception module.

FIG. 10 shows an exemplary computer screen interface for the scanning function of the conception module.

FIG. 11 shows an exemplary computer screen interface for the downloading function of the conception module.

FIGS. 12A-12C show exemplary computer screen interfaces for creating or editing exploitation decision files.

FIG. 13 shows an exemplary computer screen interface for an exploitation decision file.

FIG. 14 shows an exemplary computer screen interface for the functionality of the exploitation decision module.

FIG. 15 shows an exemplary computer screen interface for the time entry function of the exploitation decision module.

FIG. 16 shows an exemplary computer screen interface for the exploitation decision entry function of the exploitation decision module.

FIG. 17 shows an exemplary computer screen interface for the communication function of the exploitation decision module.

FIG. 18 shows an exemplary computer screen interface for the search function of the exploitation decision module.

FIG. 19 shows an exemplary computer screen interface for the scanning function of the exploitation decision module.

FIG. 20 shows an exemplary computer screen interface for the downloading function of the exploitation decision module.

FIGS. 21A-21C show exemplary computer screen interfaces for creating or editing testing files.

FIG. 22 shows an exemplary computer screen interface for a testing file.

FIG. 23 shows an exemplary computer screen interface for creating or editing a device testing file, a process testing file, or a composition of matter testing file.

FIG. 24 shows an exemplary computer screen interface for a device testing file data entry interface.

FIG. 25 shows an exemplary computer screen interface for a process testing file data entry interface.

FIG. 26 shows an exemplary computer screen interface for a composition of matter testing file data entry interface.

FIG. 27 shows an exemplary computer screen interface for the time entry function of the testing module.

FIG. 28 shows an exemplary computer screen interface for the communication function of the testing module.

FIG. 29 shows an exemplary computer screen interface for the search function of the testing module.

FIG. 30 shows an exemplary computer screen interface for the scanning function of the testing module.

FIG. 31 shows an exemplary computer screen interface for the downloading function of the testing module.

FIGS. 32A-32C show exemplary computer screen interfaces for creating or editing patent application files.

FIG. 33 shows an exemplary computer screen interface for a patent application file.

FIG. 34 shows an exemplary computer screen interface for creating or editing a provisional application file, a nonprovisional application file, an international application file, a response, or an appeal document.

FIG. 35 shows an exemplary computer screen interface for a provisional application data entry interface.

FIG. 36 shows an exemplary computer screen interface for a nonprovisional application data entry interface.

FIG. 37 shows an exemplary computer screen interface for an international application data entry interface.

FIG. 38 shows an exemplary computer screen interface for a response data entry interface.

FIG. 39 shows an exemplary computer screen interface for an appeal document interface.

FIG. 40 shows an exemplary computer screen interface for an Appeal Brief data entry interface.

FIG. 41 shows an exemplary computer screen interface for the time entry function of the patent application module.

FIG. 42 shows an exemplary computer screen interface for the communication function of the patent application module.

FIG. 43 shows an exemplary computer screen interface for the search function of the patent application module.

FIG. 44 shows an exemplary computer screen interface for the scanning function of the patent application module.

FIG. 45 shows an exemplary computer screen interface for the downloading function of the patent application module.

FIG. 46 shows an exemplary computer screen interface for the filing function of the patent application module.

FIG. 47 shows an exemplary computer screen interface for the printing function of the patent application module.

### DETAILED DESCRIPTION OF THE PREFERRED EMBODIMENT(S)

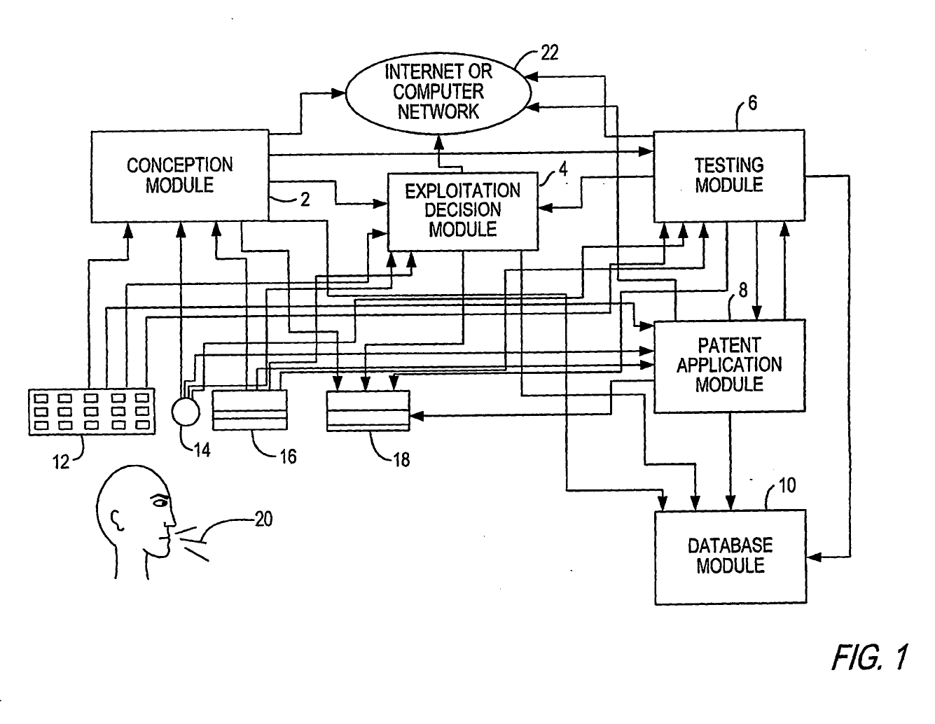

The various modules included in a preferred inventive process, documentation, management, and stimulation system, as well as their optional interactions with each other and with various external interfaces, are shown in FIG. 1. The conception module 2 assists the user in dealing with the process of conceiving a new invention, the exploitation decision module 4 assists the user in dealing with the process of deciding whether to exploit the invention, the testing module 6 assists the user in dealing with testing of the invention, the patent application module 8 assists the user with the preparation, filing, and prosecution of a patent application, and with proceedings after issuance of a patent, and the database module 10 stores data created by other modules which cannot otherwise be stored in the memory available to those modules.

The conception module 2 may be accessed and controlled by a user through, for example, a keyboard 12, a mouse 14, scanner 16, printer 18, or, if the software embodying the system is resident on a personal computer or other computing device, and if the personal computer or other computing device is enabled for voice recognition by appropriate software, the conception module 2 may be accessed and controlled by the user's voice instructions 20. A user of the conception module may also communicate over the internet or other computer network 22 with users of other copies of the software resident on other computers. Besides the use of e-mail or a chatting function to communicate over the internet, a user of the conception module 2 may conduct a voice conversation with another user over the internet if the computers used are enabled for voice communication over the internet by appropriate software. Depending on the presence of additional modules in the system other than the conception module 2, either on the same computer or another computer, some or all of the following interactions with the conception module may be applicable. The exploitation decision module 4 may obtain relevant information, such as a description of the conceived invention, from the conception module 2. In addition, the testing module 6 may also obtain relevant information, such as a description of the conceived information, and details of any physical testing contained in the conception module 2. The patent application module 8 may also obtain relevant information, such as a description of the conceived invention or steps taken in an inventive process or the process of producing an inventive product from the conception module 2. Finally, the database module 10 may store data from the conception module 2 which cannot otherwise be stored.

The exploitation decision module 4, like the conception module 2, may be accessed and controlled by a user through, for example, a keyboard 12, mouse 14, scanner 16, printer 18, or the user's voice instructions 20, and the user of the exploitation decision module 4 may communicate with users of other copies of the software though the internet or other computer network 22. Such communication over the internet or other computer network 22 may be by e-mail, chatting, or, if available, by voice. Depending on the presence of additional modules in the system other than the exploitation decision module 4, either on the same computer or on another computer, some or all of the following interactions, which have not been previously mentioned, involving the exploitation decision module 4 may apply. The exploitation decision module 4 may obtain relevant information from the testing module 6, such as information describing the prototype of the invention, the process of testing, and any results of testing. The testing module 6 may obtain relevant information from the exploitation decision module 4, such as information about the expected use of the invention or any characteristics of the invention needed to make it marketable. The patent application module 8 may obtain relevant information from the exploitation decision module 4, such as any characteristics of the invention needed to make it marketable and expected sales and revenue to be derived from the invention. The database module 10 may store the data from the exploitation decision module 4 which cannot otherwise be stored.

The testing module 6, like the conception module 2 and the exploitation decision module 4, may be accessed and controlled by a user through, for example, a keyboard 12, mouse 14, scanner 16, printer 18, or the user's voice instructions 20, and the user of the testing module 6 may communicate with users of other copies of the software resident on other computers over the internet or another computer network 22. Such communication over the internet or other computer network 22 may be by e-mail, chatting, or, if available, by voice. Depending on the presence of additional modules in the system other than the testing module 6, either on the same computer or on another computer, the following interactions with the testing module 6, which have not been mentioned previously, may apply. The testing module 6 may obtain relevant information from the patent application module 8, such as descriptions of various embodiments of the invention in any patent application being prepared or already filed. The patent application module 8 may obtain relevant information from the testing module 6, such as descriptions of any prototypes produced, description of tests conducted, and results thereof. The database module 10 may store the data from the testing module 6 which cannot otherwise be stored.

The patent application module 8, like the conception module 2, the exploitation decision module 4, and the testing module 6, may be accessed and controlled by a user, through, for example, a keyboard 12, mouse 14, scanner 16, printer 18, or the user's voice instructions 20, and the user of the patent application module may communicate over the internet or other computer network 22 with users having other copies of the software resident on their computers. Such communication over the internet or other computer network 22 may be by e-mail, chatting, or, if available, by voice. The database module 10 may store the data from the patent application module 8 which cannot otherwise be stored.

In addition to all the other interactions between the modules described above, the software should preferably allow the user of any module to do searches, based on key words or other methods well known in the art, of any other module which the user is authorized to search.

The conception module 2 will now be described in detail.

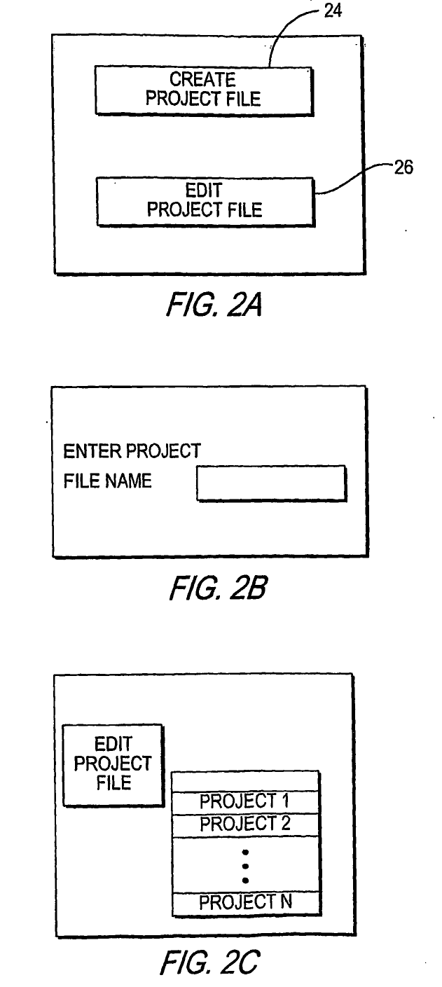

A researcher, other technical worker, or an administrator will preferably be required to organize the researcher's work into projects, which will be given distinct names as they are entered into the conception module on a worker's computer. Separate files for each project will be created by the user of the conception module. Sample interfaces displayed on a computer screen by the conception module allowing the creation or editing of project files are shown in FIGS. 2A-2C. The first interface, FIG. 2A, allows the user to create 24 or edit 26 a project file. If the user selects the option of creating 24 a project file in the first interface, the second interface appears, FIG. 2B, and allows the user to create a project file by entering a name different from the name of any existing project file. To protect the user against mistakenly creating a project file that already exists, the conception module displays an error message if such an action is attempted. If the user selects the option of editing 26 a project file in the first interface, the third interface appears, FIG. 2C, and allows the user to select a project file from a drop down list automatically appearing when the user selects the button labeled “Edit Project File”.

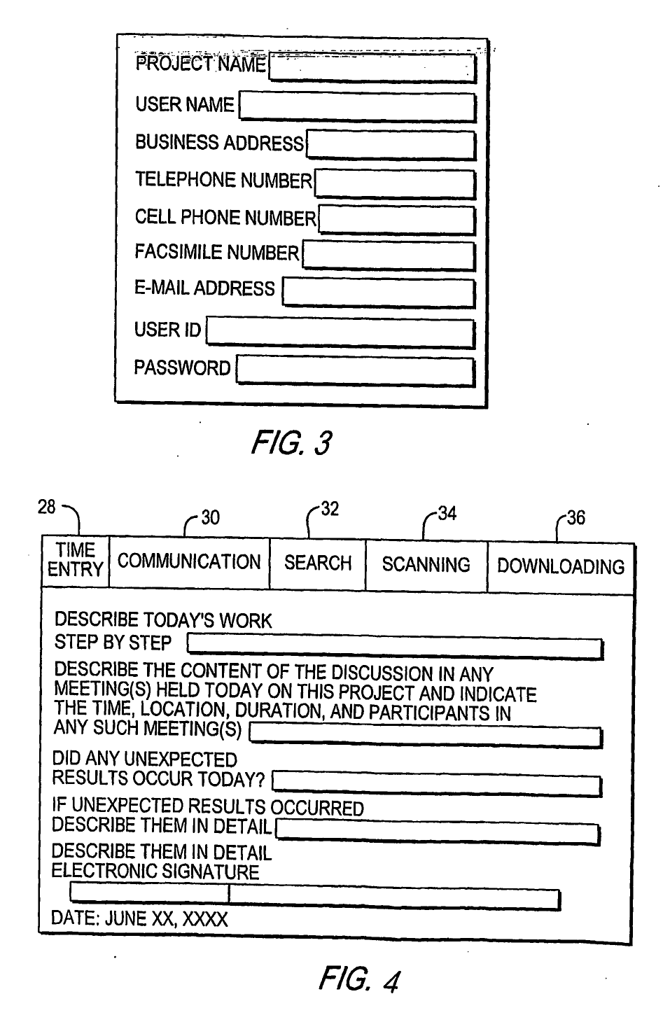

The project files will include and be accessed through project interfaces established for each project. A sample interface for a project file created by the conception module and appearing on a user's personal computer is shown in FIG. 3. The interface indicates the project name, the user or researcher's name, the business address, telephone number, cell phone number, facsimile number, and e-mail address of the user, all of which may be entered by the user. The cell phone number, facsimile number, and e-mail address of the user will preferably be optional information to be provided by the user. Each project interface will preferably allow the user or researcher to enter a user identification and password for security purposes.

After satisfying security requirements, the user will be required, by the end of each work day, to answer certain questions, which will appear on the computer screen, regarding his or her research to summarize the work done, and regarding any results of the work. Such questions may include, for example:
1. Describe your work today, step by step.
2. Describe the content of the discussion in any meeting(s) held today on this project, and indicate the time, location, duration, and participants in any such meeting(s).
3. Did any unexpected results occur today?
4. If unexpected results occurred, describe them in detail.
   Based on an affirmative answer to question three, for example, the software will ask the user whether an invention file should be established. If the user answers in the negative, the software will ask for an explanation why no invention was deemed to be conceived. A sample computer screen showing such queries is shown in FIG. 4. The interface shown in FIG. 4 also requires the inventor to enter an electronic signature, by, for example, an alphanumeric identification string unique to that research worker, in order to verify the information entered, and prevent the possibility of fraud. The date of the entry of the electronic signature will automatically be entered by the conception module. It is also preferable that the project file allow the user to perform additional functions, such as time entry 28, communication 30, search 32, scanning 34, and downloading 36, described further below. FIG. 4 shows this additional functionality through a toolbar, but another menu selection facility may also be provided.

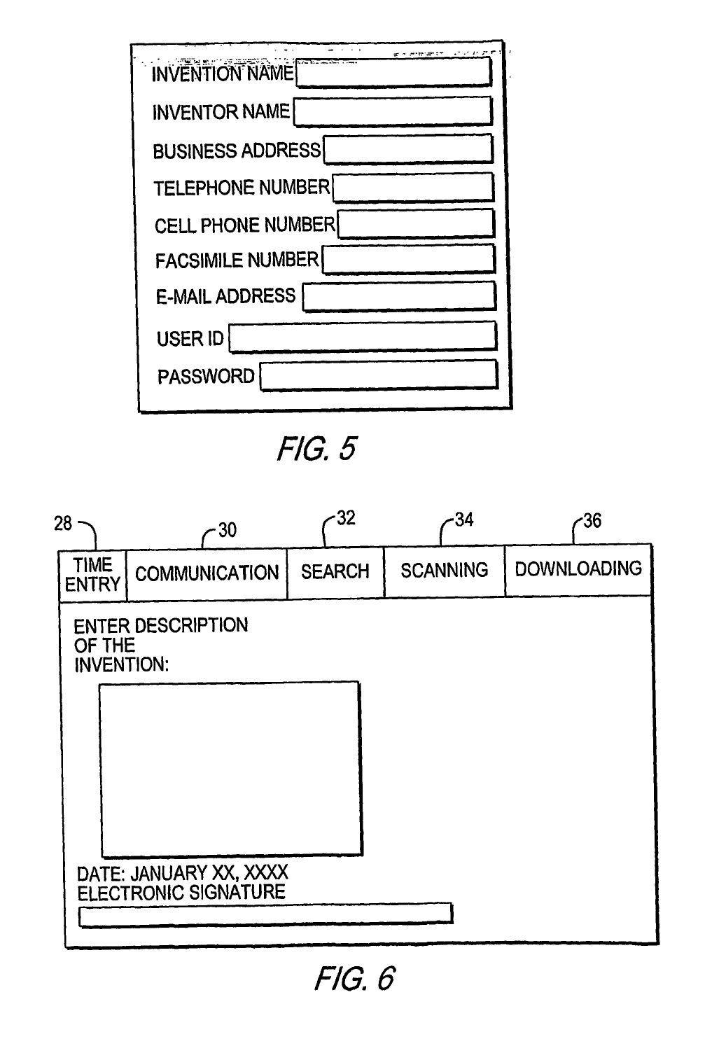

If an invention file is established, a new invention interface, shown in FIG. 5, will appear requiring the inventor to enter the name of the invention. All other information identifying the name of the inventor, business address, telephone number, and optional additional contact information previously mentioned with regard to the project interface, except for the user identification and password, will be automatically copied from the project interface, the name of the inventor being copied from the user name in the project interface, subject to editing at any time by the inventor. The invention interface will preferably allow the inventor to enter a user identification and a password to satisfy security requirements.

After satisfying security requirements, the inventor will be required to enter a description of the invention, on a new computer interface, an example of which is shown in FIG. 6. The software will automatically enter the correct date. Once the description of invention has been entered, the software will not allow editing of the description of invention on a subsequent date. If the inventor wishes to amend, add to, or otherwise change the description of invention on a subsequent date, a new description of invention must be entered. The conception module should also automatically send an e-mail or other form of electronic communication to other authorized users, alerting them that a conception has occurred, the date of conception, and the name and business address of the inventor. The interface for the entry of the description of invention will also preferably require the inventor to enter an electronic signature, by, for example, an alphanumeric identification string unique to that research worker, in order to verify the information entered, and prevent the possibility of fraud. The interface for the entry of the description of invention will also have a toolbar or other menu display allowing the user to select additional functions, such as time entry 28, communication 30, search 32, scanning 34, and downloading 36, described further below.

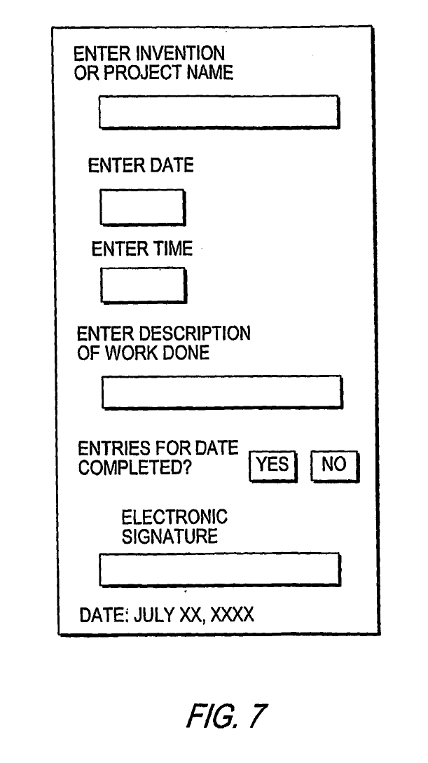

The conception module will also preferably have a time entry function 28 allowing the user to enter the time spent on each project and invention each day and a description of the work done, on a separate screen dedicated for that purpose, shown, for example, in FIG. 7, and covering all projects and inventions on which work was done. The interface shown in FIG. 7 also requires the inventor to enter an electronic signature after all of a day's entries have been completed, by, for example, an alphanumeric identification string unique to that research worker, in order to verify the information entered, and prevent the possibility of fraud. The date of the entry of the electronic signature will automatically be entered by the conception module.

The regular recordation of the research work performed by the technical worker, and the constant probing by the software to discover inventions, which may otherwise be overlooked by the inventor, should help to improve documentation of the development of any invention conceived, and stimulate the recognition of inventive conception as soon as such conception occurs.

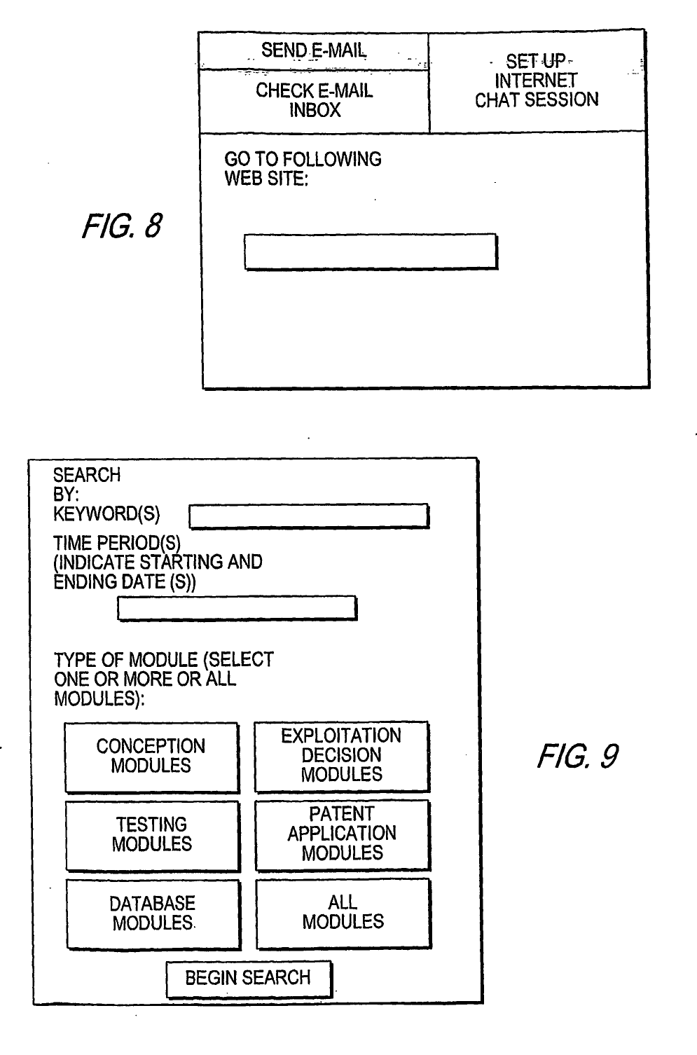

The conception module should also preferably include a communication function 30, including, for example, an internet browser, e-mail capability, and chat capability. A sample interface for the internet browser, e-mail, and chat functions is shown in FIG. 8. The internet browser may be employed by the user, for example, to search the internet to perform any desired related art searches, the results of which will, preferably, be automatically saved by the conception module, for later reference by an authorized user. E-mails and internet chat may be used to communicate with other users having the system software, such users being members of the same organization or other organizations, provided security requirements are met, and also other technical workers in general. Such communication with other users and technical workers may help to assist and stimulate the inventive process by, for example, inquiring about work and results of others working in related technical fields or working on related technical problems.

Such assistance and stimulation of the inventive process will also be furthered by a preferably included search feature 32 of the conception module. A sample computer screen showing an interface for such a search feature is shown in FIG. 9. Such a search feature will allow search of information contained within accessible system modules resident on computers in the same organization or in other organizations. Such searches could, for example, be based on key words or other methods well known in the art. Such searches would preferably not include any ability to change or otherwise edit the modules searched. Searches could be limited by time periods, or types of modules searched, for example.

The search results, if the search is conducted by keyword, could typically indicate each occurrence of the keyword, in a list where each occurrence has the location indicated by a particular project file name, invention file name, exploitation decision file name, testing file name, or patent application file name, as applicable, each file name being a hyperlink, which will take the user to the occurrence of the keyword in the appropriate file upon the user clicking on the file name with a mouse or other input device, for example. The entire file will be available for display, however, to the user upon the user arriving at the location of a keyword which occurs in a particular file. Search results will, preferably, automatically be saved by the conception module, in the particular project or invention file in which the search was conducted, and can thereafter be accessed by an authorized user. Search results could assist in and stimulate the inventive process by, for example, indicating a “dead end” to a certain research approach, promising results obtained by others in the field, the economic impracticability of certain inventive ideas, based on marketing or other commercial studies, the failure or success of certain inventive products based on actual testing, or further ideas for follow up investigation.

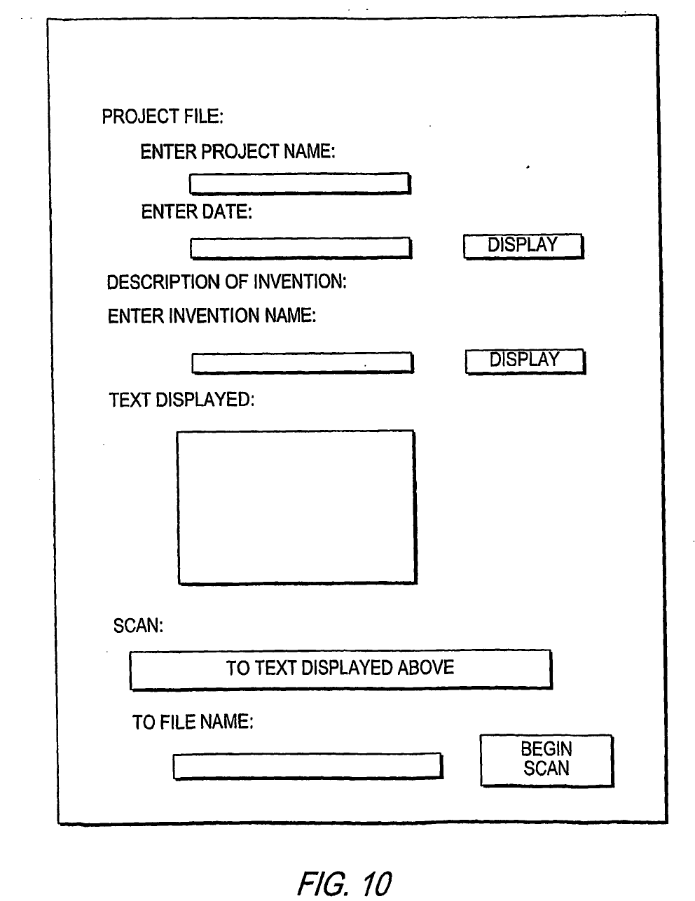

The scanning function 34 of the conception module preferably possesses a user interface, an exemplary user interface being shown in FIG. 10. The scanning function would, preferably, allow the choice of the scanned image being incorporated in the project file or description of invention being displayed, beginning at the location of the cursor on the computer screen, or would allow a user to create a file, linked to the displayed project file or description of invention, to hold the scanned image. The scanning function would allow the incorporation of relevant documents and drawings into the appropriate file, so as to create as complete a record of a project or an invention as possible.

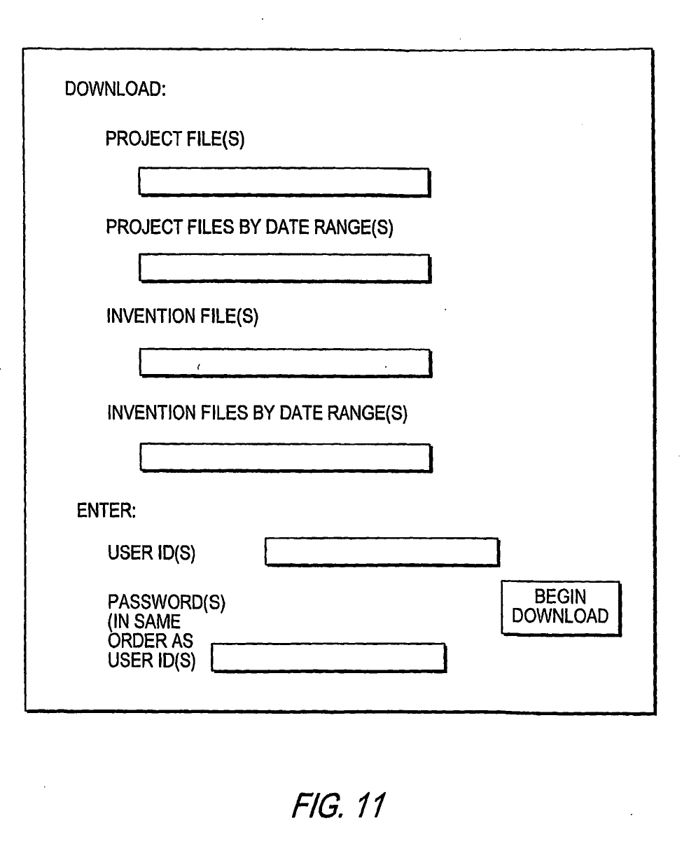

The downloading function 36 of the conception module preferably possesses a user interface, an exemplary user interface being shown in FIG. 11. The downloading function would allow the downloading, over the internet or other computer network, of specific project files or invention files or groups of project files or invention files by specified date of creation ranges from other copies of the conception module resident on other computers than the computer from which the download is being performed. The downloading function would be capable of addressing particular conception modules in an organization or performing the download over all conception modules in an organization. In order to successfully perform the download, the user would need to know the user identification(s) and password(s) of the user(s) whose conception modules are the target(s) of the download or the user identification and password of the organization's conception modules, which are the target of the download, in order to enter them in the download interface. Of course, if the memory available to a conception module would be exceeded by such a download, the software would display an error message instead of performing the download. Such a function may be of great use to the legal department of the organization or any independent law firm retained by the organization to perform patent work on its behalf. For example, the downloading function can be used to monitor research worker progress as it occurs, allowing legal personnel to elicit additional information if they deem it necessary. In addition, the downloading function may be used to obtain relevant conception information during the preparation of a patent application, during the prosecution of an application to obtain a patent, and during any patent litigation or any other post-patent issuance proceeding. Furthermore, the downloading function would allow the downloading of specific invention or project files or groups of invention or project files within specified date ranges from the conception module resident on a certain computer to a portable drive or other portable memory media for archiving the files, thus releasing the memory on the computer occupied by those files, upon deletion of those files, the conception module allowing an authorized user to delete any entire project or invention file at the discretion of the authorized user.

The exploitation decision module 4, assisting in the decision whether to exploit the conceived invention, will now be described in detail.

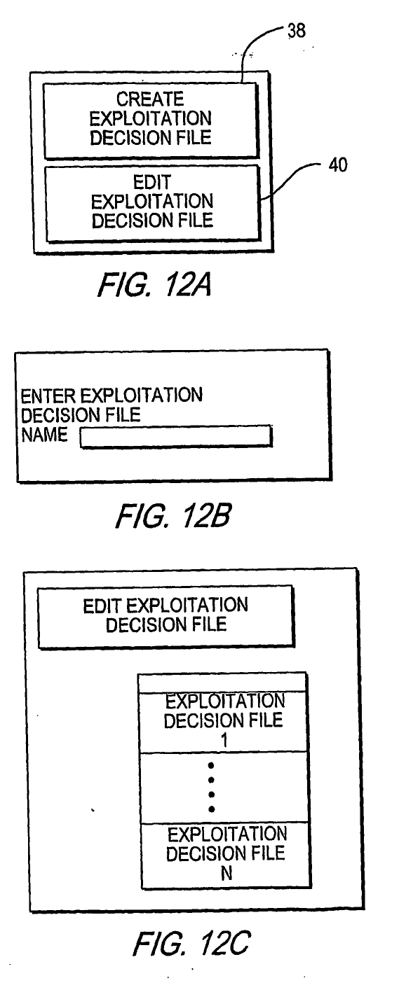

If the conception module is installed in an organization and a conception has occurred in the organization, an exploitation decision file will automatically be created for the invention identified by the name of the invention designated by the inventor. Otherwise, the appropriate user will be required to create such an exploitation decision file for the conceived invention in question. Sample interfaces displayed on a computer screen by the exploitation decision module allowing the creation or editing of exploitation decision files are shown in FIGS. 12A-12C. The first interface, FIG. 12A, allows the user to create 38 or edit 40 an exploitation decision file. If the user selects the option of creating an exploitation decision file in the first interface, the second interface appears, FIG. 12B, and allows the user to create an exploitation decision file by entering the name, the name preferably being limited to the name of the invention. To protect the user against mistakenly creating an exploitation decision file for an invention where that exploitation decision file already exists, the exploitation decision module displays an error message if such an action is attempted. If the user selects the option of editing an exploitation decision file in the first interface, the third interface appears, FIG. 12C, and allows the user to select an exploitation decision file from a drop down list automatically appearing when the user selects the button labeled “Edit Exploitation Decision File”.

It should be noted that the exploitation decision module typically will only be installed on the computers of those employees or management personnel involved with or responsible to make a decision to exploit the conceived invention. This would typically include such departments as legal, marketing, sales, or accounting, and management personnel such as officers or board members of a company.

In the case of individual self-employed inventor(s), the exploitation decision module will, if purchased, be installed on whichever computer the inventor(s) decide as the inventor(s) will normally be using it to make a decision whether or not to exploit the invention.

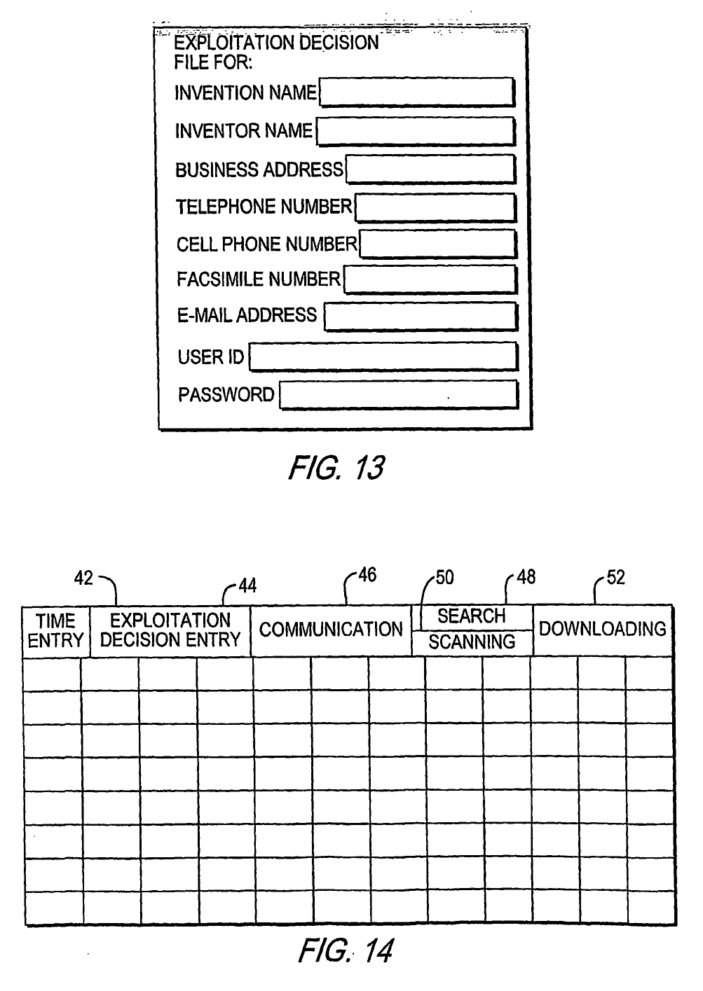

FIG. 13 shows a sample computer screen displaying an exploitation decision interface included in an exploitation decision file. The interface identifies the invention for which the exploitation decision file has been established, along with the name, business address, telephone number, cell phone number, facsimile number, and e-mail address of the inventor. The invention name and the name and all other contact information of the inventor will be automatically copied from the appropriate invention file in the conception module, provided that the conception module is installed as part of the software purchased. The cell phone number, facsimile number, and e-mail address of the inventor should preferably be optional information. The interface also preferably requires the user to enter a user identification and password, for example, to satisfy security requirements. Once security requirements are satisfied, the user can access the functionality of the exploitation decision module.

A sample interface for such functionality of the exploitation decision module is shown in FIG. 14. A spreadsheet for financial calculations to determine various financial projections for the invention would, for example, appear. The exploitation decision module would, for example, be able to produce projections for sales and revenue from the invention, given appropriate input information such as an expected sale price and costs to produce and sell the invention. Any other functions commonly available in present financial and accounting software could be included in the exploitation decision module. The exploitation decision module should preferably be capable of importing any relevant financial and accounting information, which is maintained by the organization in compatible electronic form, so as to enable the user to employ that information to arrive at a decision whether or not to exploit the invention. Alternatively, the scanning function 50 of the exploitation decision module, described further below, may be used to input any relevant financial and accounting information into the exploitation decision module. The interface of the exploitation decision module, preferably including a spreadsheet, will also preferably include a toolbar or other menu selection device to select additional functions, such as time entry 42, exploitation decision entry 44, communication 46, search 48, scanning 50, and downloading 52, described further below.

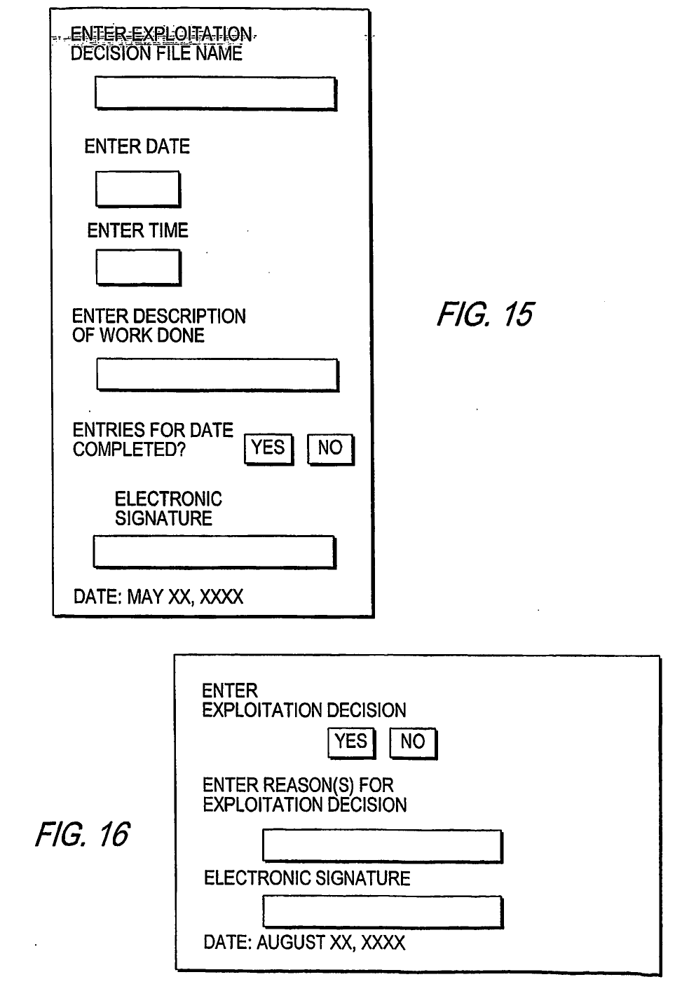

The exploitation decision module will preferably have a time entry function 42, allowing the user to enter the time spent on each exploitation decision file each day and a description of the work done, on a separate screen dedicated for that purpose, shown, for example, in FIG. 15, and covering all exploitation decision files on which work was done. FIG. 15 also requires the authorized user to enter an electronic signature after all of a day's entries have been completed, by, for example, an alphanumeric identification string unique to that authorized user, in order to verify the information entered, and prevent the possibility of fraud. The date of the entry of the electronic signature will automatically be entered by the exploitation decision module.

The exploitation decision module should preferably include an exploitation decision entry function 44. When the exploitation decision entry function is selected, an interface, an example of which is shown in FIG. 16, will appear. The interface will allow the user to enter a “yes” or “no” decision on exploitation, and the reason(s) for the decision. Documents and drawings, which are part of the basis of the decision, can be scanned in using the scanning function. FIG. 16 also requires the authorized user to enter an electronic signature, after an exploitation decision and the reason(s) for the decision have been entered, by, for example, an alphanumeric identification string that is unique to that authorized user, in order to verify the information entered, and prevent the possibility of fraud. The date of the entry of the electronic signature will automatically be entered by the exploitation decision module.

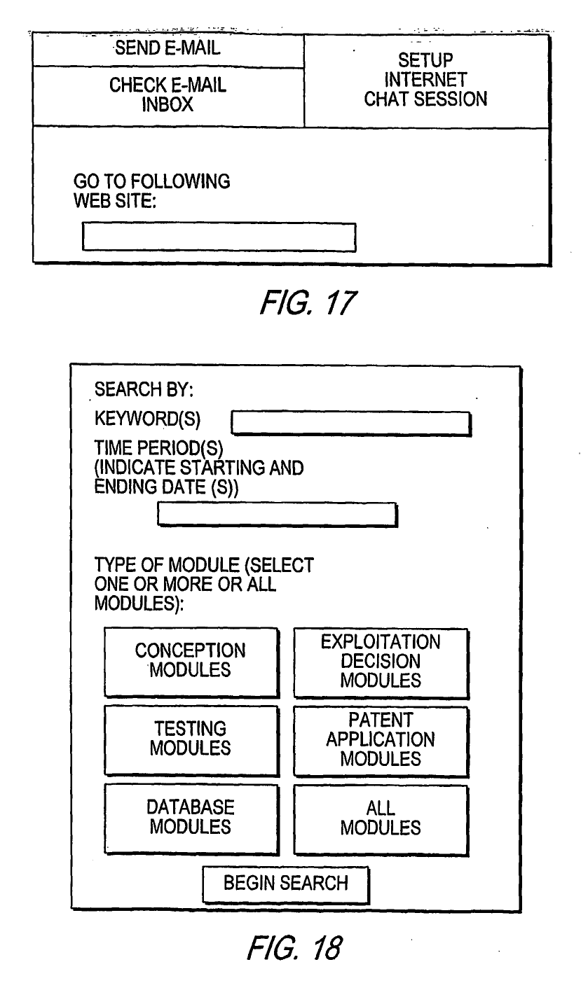

The exploitation decision module should preferably include a communication function 46, including, for example, an internet browser, e-mail capability, and chat capability. A sample interface for the internet browser, e-mail, and chat functions is shown in FIG. 17. The internet browser may be employed by the user, for example, to search the internet in any related art searches desired to be performed by the user or searches for any similar products to the invention, which are presently being sold. The results of searches performed will, preferably, be automatically saved by the exploitation decision module, for later reference by an authorized user. E-mails and internet chat may be used to communicate with other users having the system software, such users being members of the same organization or other organizations, provided security requirements are met, and also other persons employed in finance and accounting in the same organization. Such communication with other users and financial and accounting personnel in the same organization may help to assist and stimulate the inventive process by, for example, inquiring about the commercial success of products similar to the inventive product.

Such assistance and stimulation of the inventive process will also be furthered by a preferably included search feature 48 of the exploitation decision module. A sample computer screen showing an interface for such a search feature is shown in FIG. 18. Such a search feature will allow search of information contained within accessible system modules resident on computers in the same organization or in other organizations. Such searches could, for example, be based on key words or other methods well known in the art. Such searches would preferably not include any ability to change or otherwise edit the modules searched. Searches could be limited by time periods or the designation of modules searched, for example. Search results will, preferably, automatically be saved by the exploitation decision module in the particular exploitation decision file in which the search was conducted, and can thereafter be accessed by an authorized user.

The search results, if the search is conducted by keyword, could typically indicate each occurrence of the keyword, in a list where each occurrence has the location indicated by a particular project file name, invention file name, exploitation decision file name, testing file name, or patent application file name, as applicable, each file name being a hyperlink, which will take the user to the occurrence of the keyword in the appropriate file upon the user clicking on the file name with a mouse or other input device, for example. The entire file will be available for display, however, to the user upon the user arriving at the location of a keyword which occurs in a particular file. Search results could assist in and stimulate the inventive process by, for example, indicating a commercial success or failure for products similar to the inventive product, based on financial results for those products, or marketing or other commercial studies, the failure or success of operation of inventions similar to the inventive product, based on actual testing, or further ideas for follow up investigation.

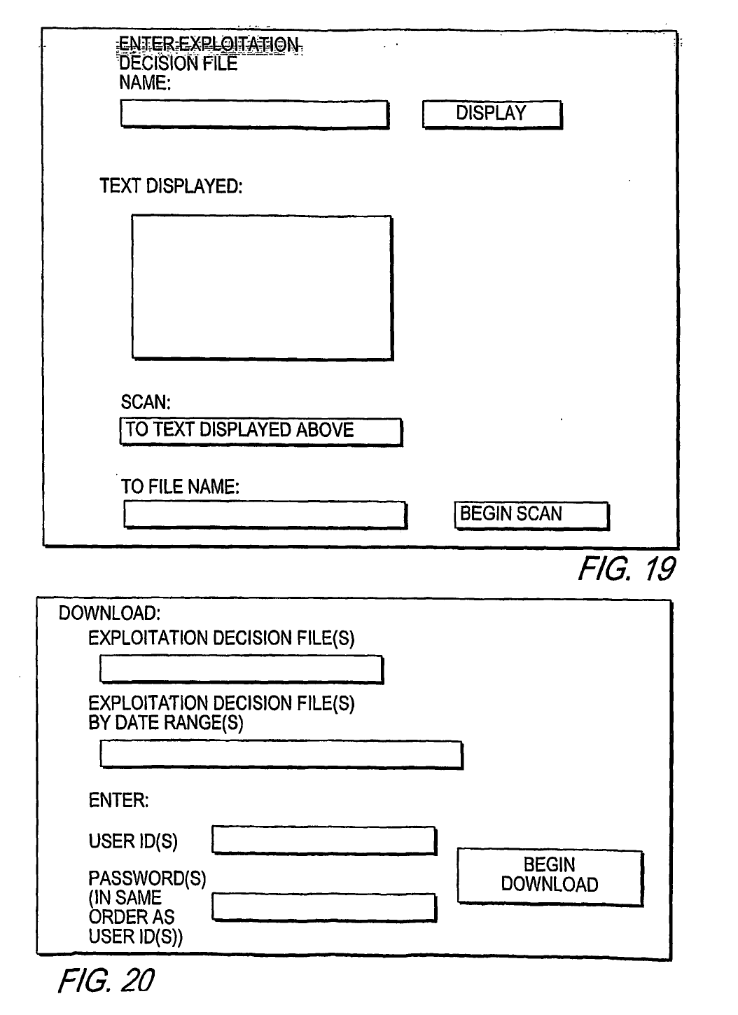

The scanning function 50 of the exploitation decision module preferably possesses a user interface, an exemplary user interface being shown in FIG. 19. The scanning function would, preferably, allow the choice of the scanned image being incorporated in the exploitation decision file being displayed, beginning at the location of the cursor on the computer screen, or would allow a user to create a file, to be linked to the displayed exploitation decision file, to hold the scanned image. The scanning function would allow the incorporation of relevant documents and drawings into the appropriate file, so as to create as complete a record of an exploitation decision as possible.

The downloading function 52 of the exploitation decision module preferably possesses a user interface, an exemplary user interface being shown in FIG. 20. The downloading function would allow the downloading, over the internet or other computer network, of specific exploitation decision files or groups of exploitation decision files by specified date of creation ranges from other copies of the exploitation decision module resident on other computers than the computer from which the download is being performed. The downloading function would be capable of addressing particular exploitation decision modules in an organization or performing the download over all exploitation decision modules in an organization. In order to successfully perform the download, the user would need to know the user identification(s) and password(s) of the user(s) whose exploitation decision modules are the target(s) of the download or the user identification and password of the organization's exploitation decision modules, which are the target of the download, in order to enter them in the download interface. Of course, if the memory available to an exploitation decision module would be exceeded by such a download, the software would display an error message instead of performing the download. Such a function may be of great use to the legal department of the organization or any independent law firm retained by the organization to perform patent work on its behalf. For example, the downloading function can be used to obtain relevant financial information and related art searches during the preparation of a patent application, during the prosecution of an application to obtain a patent, and during any patent litigation or other post-patent issuance proceeding. Furthermore, the downloading function would allow the downloading of specific exploitation decision files or groups of exploitation decision files within specified date ranges from the exploitation decision module resident on a certain computer to a portable drive or other portable memory media for archiving the files, thus releasing the memory on the computer occupied by those files, upon deletion of those files, the exploitation decision module allowing an authorized user to delete any entire exploitation decision file at the discretion of the authorized user.

A detailed description of the testing module 6, assisting in the testing of the invention, follows.

The testing module will typically only be installed on computers of those departments of the organization involved in the construction of prototypes of inventions, if necessary, and the testing of the invention, and the legal department, if it is desired for the legal department to monitor and be able to access testing data. A testing module can also be installed on computers of any independent law firm selected by the organization to handle their patent work, as well as computers of an independent testing firm selected by the organization. Since a decision to test will normally be made by the organization on an invention-by-invention basis, each testing file will be created by an authorized user. Of course, in the event that the organization has a policy to test every invention, the testing module may have the feature of automatically establishing a testing file when any other installed module is provided with information indicating that an invention has been made, the relevant information being copied from the other installed module. For individual self-employed inventor(s), a testing module could be installed on the personal computer(s) of the inventor(s) or of a testing firm hired by the inventor(s) and also on the computer(s) of any attorney or law firm retained by the inventor(s).

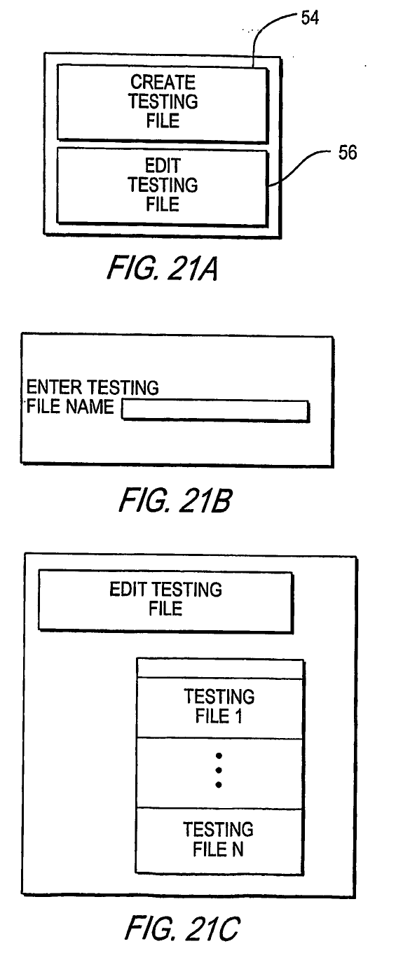

Sample interfaces displayed on a computer screen by the testing module allowing the creation or editing of testing files are shown in FIGS. 21A-21C. The first interface, FIG. 21A, allows the user to create 54 or edit 56 a testing file. If the user selects the option of creating a testing file in the first interface, the second interface appears, FIG. 21B, and allows the user to create a testing file by entering the name, which should, preferably, be the name of the invention for which testing is being performed. To protect the user against mistakenly creating a testing file for an invention where a testing file already exists for that invention, the testing module displays an error message if such an action is attempted. If the user selects the option of editing a testing file in the first interface, the third interface appears, FIG. 21C, and allows the user to select a testing file from a drop down list automatically appearing when the user selects the button labeled “Edit Testing File”.

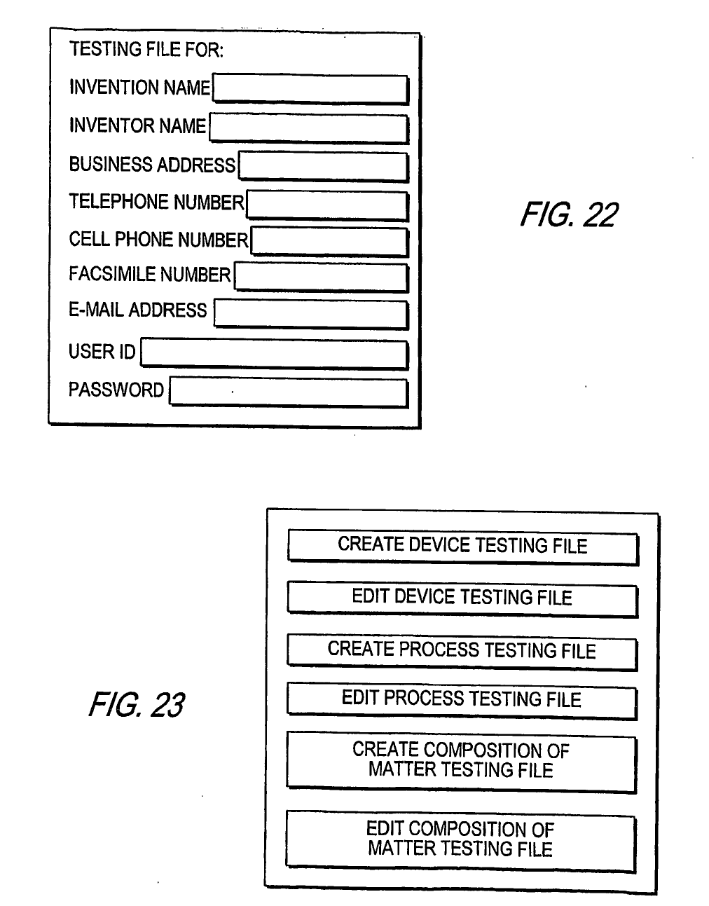

The testing files will include and be accessed through testing file interfaces established for each testing file. A sample interface for a testing file created by the testing file module and appearing on a user's personal computer is shown in FIG. 22. The interface indicates the invention name, the inventor's name, the business address, telephone number, cell phone number, facsimile number, and e-mail address of the inventor, all of which may be entered by the user or supplied by the testing module, when available. The cell phone number, facsimile number, and e-mail address of the inventor will preferably be optional information. Each testing file interface will preferably allow the user to enter a user identification and password for security purposes.

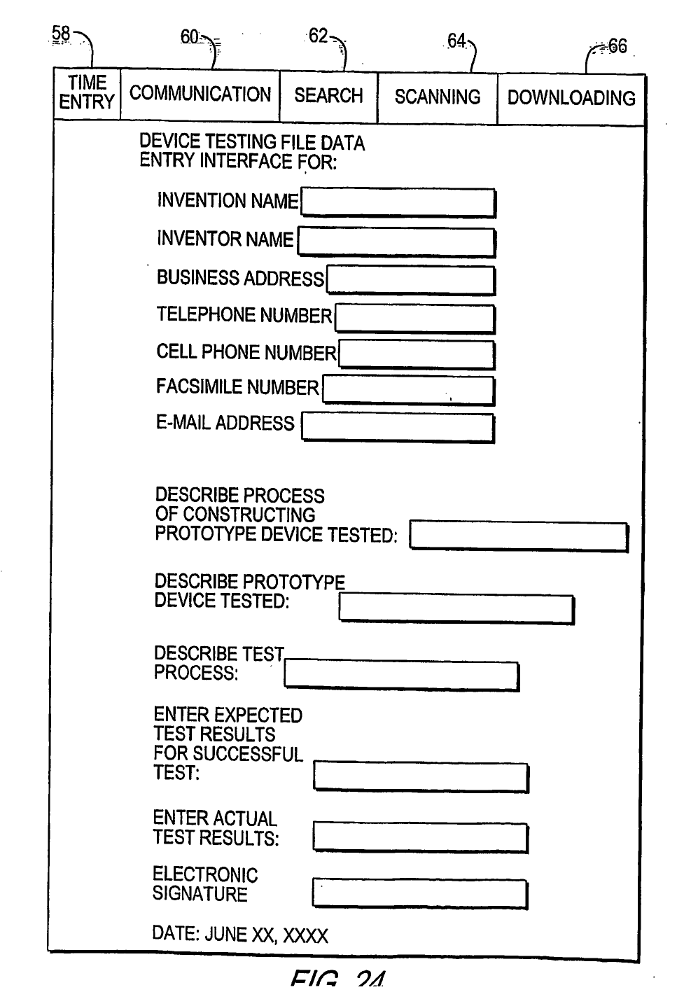

Once a user has satisfied security requirements by, for example, entering a valid user identification and password combination, a further interface will appear prompting the user to create or edit one of three types of testing files, a device testing file, a process testing file, or a composition of matter testing file, the appropriate type of testing file being selected by a user, based on the type of invention being tested. An exemplary interface providing these options is shown in FIG. 23. Based on the selection by the user of the option in the interface exemplified by FIG. 23, one of three new or existing types of testing file data entry interfaces will appear, namely, a device testing file data entry interface, a process testing file data entry interface, or composition of matter testing file data entry interface. To protect the user against mistakenly creating a certain type of testing file for an invention where that type of testing file or a different type of testing file already exists for that invention, an error message is displayed by the testing module if such an action is attempted.

An exemplary device testing file data entry interface is shown in FIG. 24. The device testing file data entry interface has all the data entered in the previously mentioned testing file interface, except for the user identification and password, such data being automatically copied into it by the testing module. In addition, the user is preferably required to describe the process of constructing the prototype device tested, if applicable, the prototype device tested, the test process, the expected test results for a successful test, and the actual test results. All entries are made by either manual text entry or by scanning in, for example, documents, drawings, or blueprints. The person making the entries is required to enter his or her assigned alphanumeric identification string as an electronic signature for verification purposes, and the testing module will automatically enter the date of the electronic signature. The device testing file data entry interface will also have a toolbar or other menu display allowing the user to select additional functions, such as time entry 58, communication 60, search 62, scanning 64, and downloading 66, described further below.

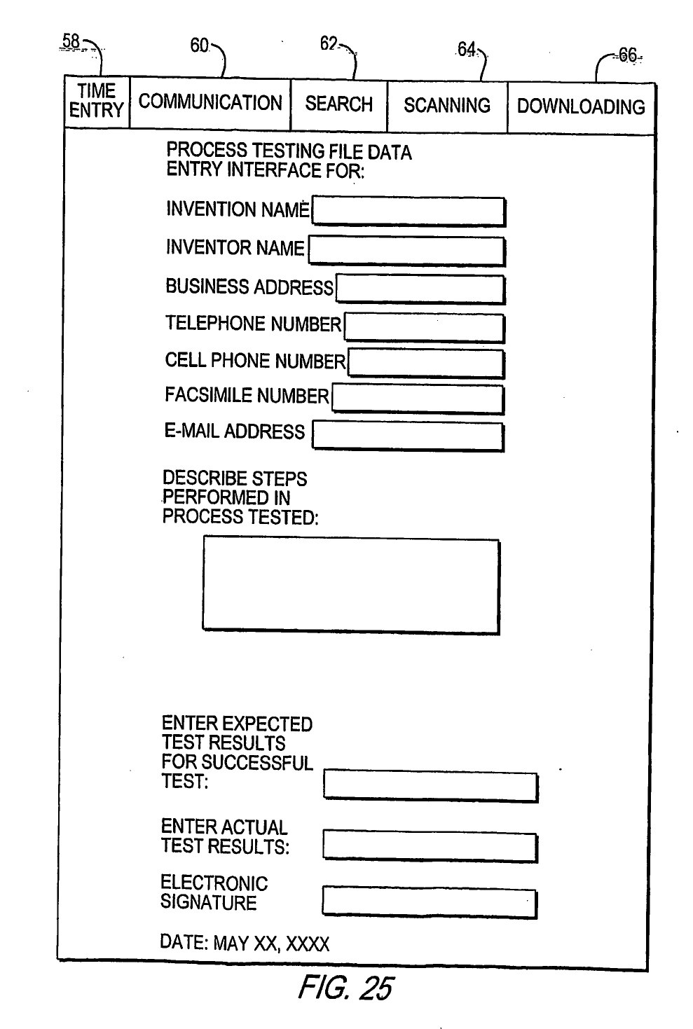

An exemplary process testing file data entry interface is shown in FIG. 25. The process testing data entry interface has all the data entered in the previously mentioned testing file interface, except for the user identification and password, such data being automatically copied into it by the testing module. In addition, the user is required to describe the steps performed in the process tested, the expected test results for a successful test, and the actual test results. All entries are made by either manual text entry or by scanning in, for example, documents, drawings, or blueprints. The person making the entries is required to enter his or her assigned alphanumeric identification string as an electronic signature for verification purposes, and the testing module will automatically enter the date of the electronic signature. The process testing file data entry interface will also have a toolbar or other menu display allowing the user to select additional functions, such as time entry 58, communication 60, search 62, scanning 64, and downloading 66, described further below.

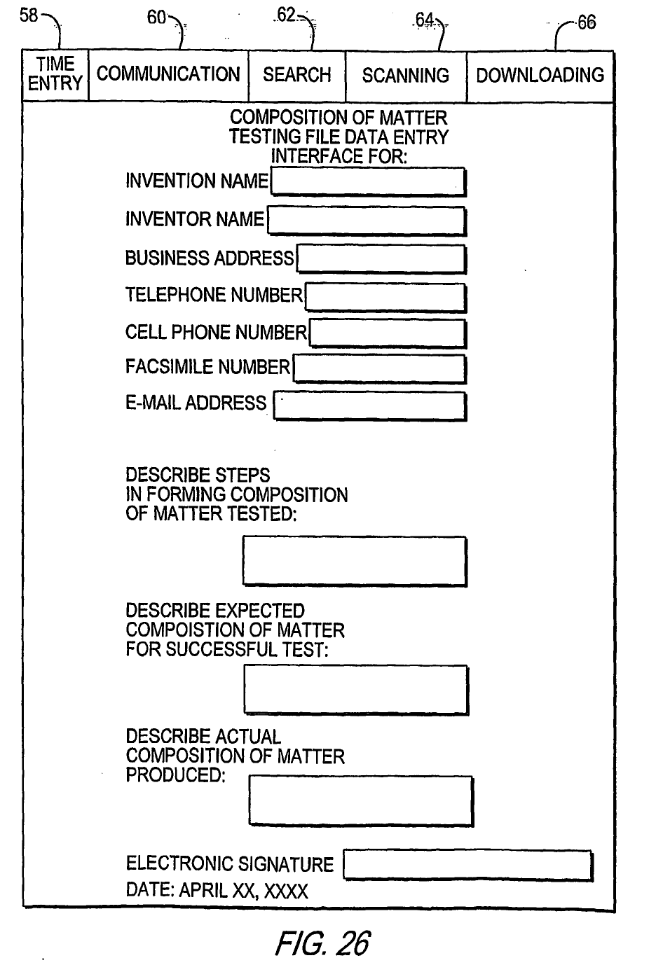

An exemplary composition of matter testing file data entry interface is shown in FIG. 26. The composition of matter testing data entry interface has all the data entered in the previously mentioned testing file interface, except for the user identification and password, such data being automatically copied into it by the testing module. In addition, the user is required to describe the steps in the process of forming the composition of matter tested, a description of the expected resulting composition of matter for a successful test, and a description of the actual composition of matter produced. All entries are made by either manual text entry or by scanning in, for example, documents, drawings, or blueprints. The person making the entries is required to enter his or her assigned alphanumeric identification string as an electronic signature for verification purposes, and the testing module will automatically enter the date of the electronic signature. The composition of matter testing file data entry interface will also have a toolbar or other menu display allowing the user to select additional functions, such as time entry 58, communication 60, search 62, scanning 64, and downloading 66, described further below.

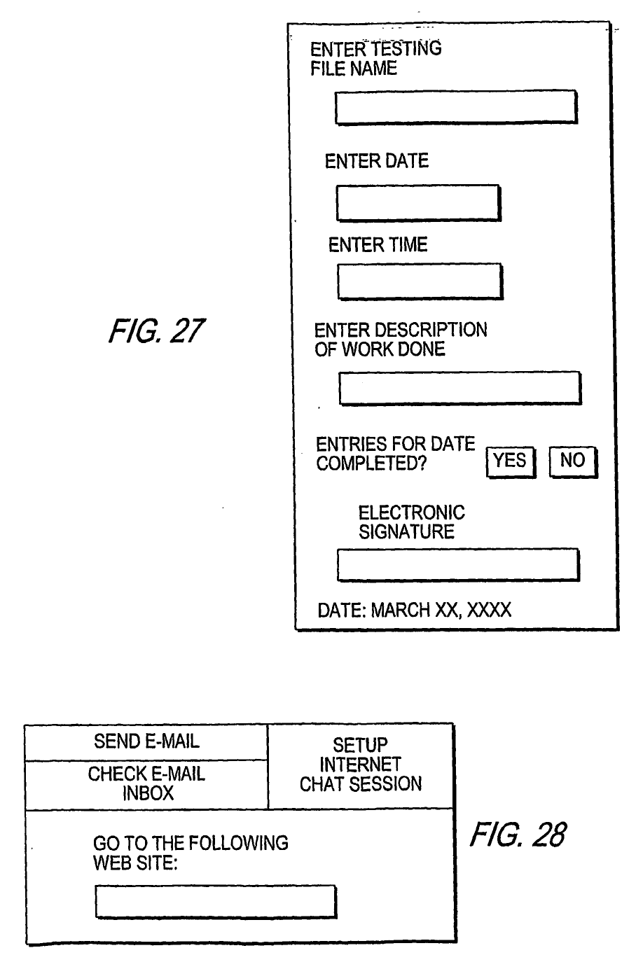

The testing module will also preferably have a time entry function 58 allowing the user to enter the time spent on each testing file each day and a description of the work done, on a separate screen dedicated for that purpose, shown, for example, in FIG. 27, and covering all testing files on which work was done. FIG. 27 also requires the user to enter an electronic signature after all of a day's entries have been completed, by, for example, an alphanumeric identification string that is unique to that user, in order to verify the information entered, and prevent the possibility of fraud. The date of the entry of the electronic signature will automatically be entered by the testing module.

The testing module should also preferably include a communication function 60, including, for example, an internet browser, e-mail capability, and chat capability. A sample interface for the Internet browser, e-mail, and chat functions is shown in FIG. 28. The Internet browser may be employed by the user, for example, to search the internet to perform any related art searches or searches for products or processes similar to the one(s) being tested desired to be performed by the user, the results of which will, preferably, be automatically saved by the testing module, for later reference by an authorized user. E-mails and Internet chat may be used to communicate with other users having the system software, such users being members of the same organization or other organizations, provided security requirements are met, and also other technical workers in general. Such communication with other users and technical workers may help to assist and stimulate the inventive process by, for example, inquiring about work, and results of others working in related technical fields or working on related technical problems.

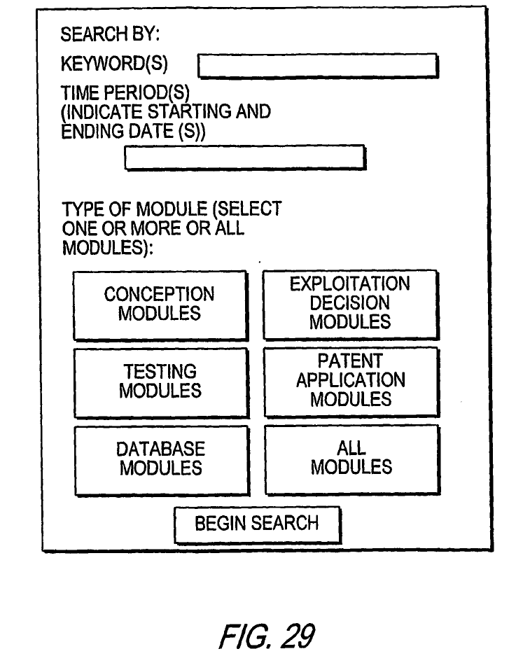

Such assistance and stimulation of the inventive process will also be furthered by a preferably included search feature 62 of the testing module. A sample computer screen showing an interface for such a search feature is shown in FIG. 29. Such a search feature will allow search of information contained within accessible system modules resident on computers in the same organization or in other organizations. Such searches could, for example, be based on key words or other methods well known in the art. Such searches would preferably not include any ability to change or otherwise edit the modules searched. Searches could be limited by time periods or the designation of modules searched, for example. Search results will, preferably, automatically be saved by the testing module in the particular testing file in which the search was conducted, and can thereafter be accessed by an authorized user.

The search results, if the search is conducted by keyword, could typically indicate each occurrence of the keyword, in a list where each occurrence has the location indicated by a particular project file name, invention file name, exploitation decision file name, testing file name, or patent application file name, as applicable, each file name being a hyperlink, which will take the user to the occurrence of the keyword in the appropriate file upon the user clicking on the file name with a mouse or other input device, for example. The entire file will be available for display, however, to the user upon the user arriving at the location of a keyword which occurs in a particular file. Search results will, preferably, automatically be saved by the testing module, in the particular testing file in which the search was conducted, and can thereafter be accessed by an authorized user. Search results could assist in and stimulate the inventive process by, for example, indicating a “dead end” to a certain testing approach, promising results or failure by others in the field, the economic impracticability of certain inventive ideas, based on marketing or other commercial studies, the failure or success of certain inventive products based on actual testing, or further ideas for follow up investigation.

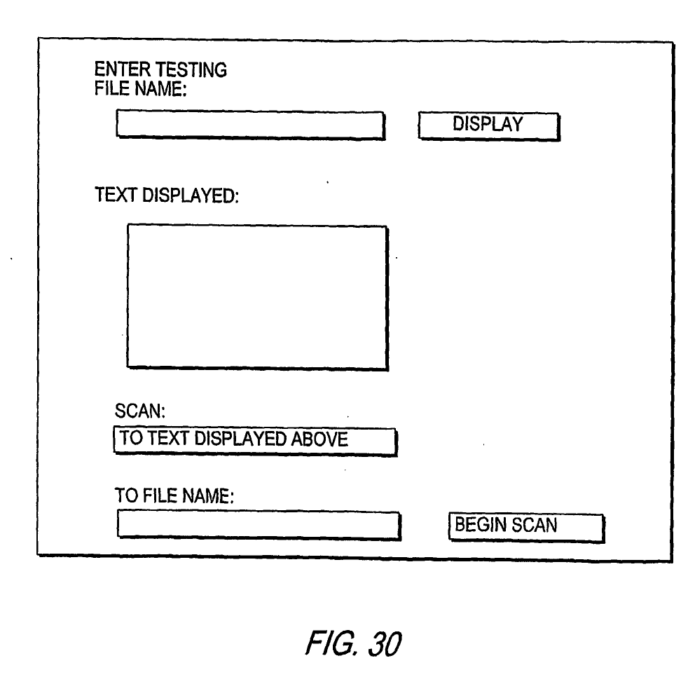

The scanning function 64 of the testing module preferably possesses a user interface, an exemplary user interface being shown in FIG. 30. The scanning function would, preferably, allow the choice of the scanned image being incorporated in the testing file being displayed, beginning at the location of the cursor on the computer screen, or would allow a user to create a file, linked to the displayed testing file, to hold the scanned image. The scanning function would allow the incorporation of relevant documents and drawings into the appropriate file, so as to create as complete a record of a test as possible.

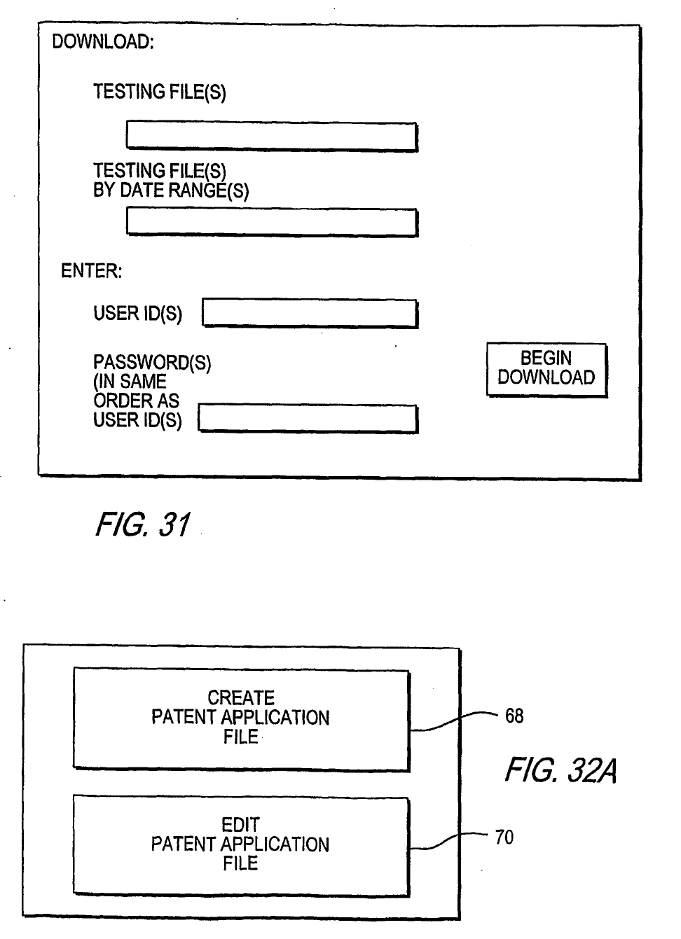

The downloading function 66 of the testing module preferably possesses a user interface, an exemplary user interface being shown in FIG. 31. The downloading function would allow the downloading, over the internet or other computer network, of specific testing files or groups of testing files with specified date of creation ranges from other copies of the testing module resident on other computers than the computer from which the download is being performed. The downloading function would be capable of addressing particular testing modules in an organization or performing the download over all testing modules in an organization. In order to successfully perform the download, the user would need to know the user identification(s) and password(s) of the user(s) whose testing modules are the target(s) of the download or the user identification and password of the organization's testing modules, which are the target of the download, in order to enter them in the download interface. Of course, if the memory available to a testing module would be exceeded by such a download, the software would display an error message instead of performing the download. Such a function may be of great use to the legal department of the organization or any independent law firm retained by the organization to perform patent work on its behalf. For example, the downloading function can be used to monitor testing worker progress as it occurs, allowing legal personnel to elicit additional information if they deem it necessary. In addition, the downloading function may be used to obtain relevant testing information during the preparation of a patent application, during the prosecution of an application to obtain a patent, and during any patent litigation. Furthermore, the downloading function would allow the downloading of specific testing files or groups of testing files within specified date ranges from the testing module resident on a certain computer to a portable drive or other portable memory media for archiving the files, thus releasing the memory on the computer occupied by those files, upon deletion of those files, the testing module allowing an authorized user to delete any entire testing file at the discretion of the authorized user.

A detailed description of the patent application module 8, assisting in, for example, the preparation, filing and prosecution of patent application(s) for inventions, and in litigation or in any other proceedings involving issued patents, follows.

The patent application module will typically only be installed on computers of those departments of an organization involved in the preparation, filing, and prosecution of patent application(s) for inventions or in any proceedings conducted after issuance of a patent, such as, for example, the research and development department, the legal department, and management. A patent application module can also be installed on computers of any independent law firm(s) in one or more countries selected by the organization to handle their patent work. Since a decision to file patent application(s) will normally be made by the organization on an invention-by-invention basis, each patent application file will be created by an authorized user. Of course, in the event that the organization has a policy to file a patent application on every invention or on every invention on which a positive decision to exploit the invention has been made, the patent application module may have the feature of automatically establishing a patent application file when any other installed module is provided with information indicating that an invention has been made or when an installed exploitation decision module is provided with notification that a positive exploitation decision has been made with regard to a particular invention, the relevant information being copied from the other installed module. For individual self-employed inventor(s), the patent application module will typically be installed on personal computer(s) of the attorney(s) retained by the inventor(s) to handle the patent work of the inventor(s).

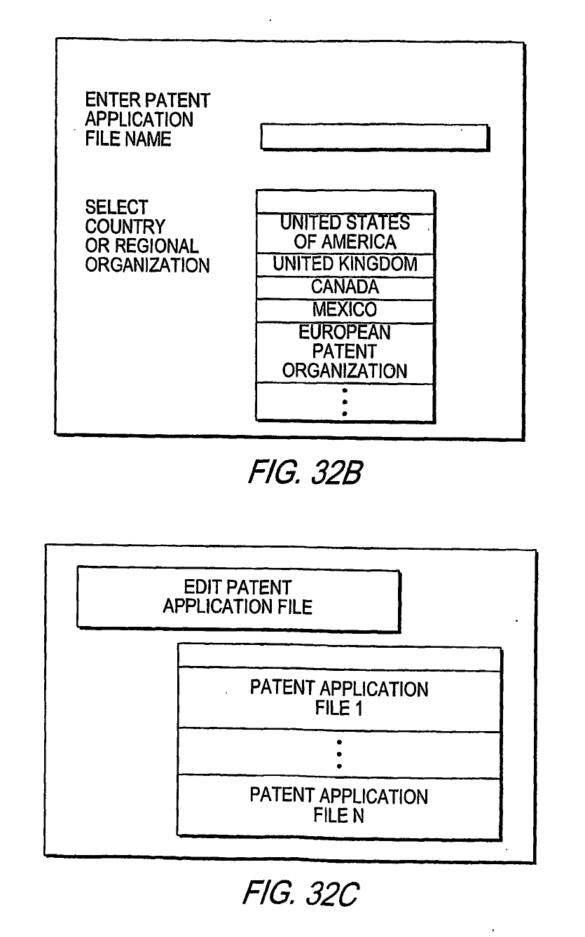

Sample interfaces displayed on a computer screen by the patent application module allowing the creation or editing of patent application files are shown in FIGS. 32A-32C. The first interface, FIG. 32A, allows the user to create 68 or edit 70 a patent application file. If the user selects the option of creating a patent application file in the first interface, the second interface appears, FIG. 32B, and allows the user to create a patent application file by entering, for example, the name of the invention, and the country or regional organization in which a patent application is desired to be filed, from a drop down list. To protect the user against mistakenly creating a new patent application file for a particular invention and country or regional organization where such a patent application file already exists, the patent application module will display an error message if such an action is attempted. In the description that follows, it is assumed that United States applications or an international application are to be filed to simplify the disclosure. Continuations, divisionals, and continuations-in-part of a parent application can be named, for example, with the name of the invention plus a suffix to indicate the type of continuing application, such as “con” for a continuation, “div” for a divisional, “cip” for a continuation-in-part, “con2” for a second continuation application in a chain of continuing applications, etc. If the user selects the option of editing a patent application file in the first interface, the third interface appears, FIG. 32C, and allows the user to select a patent application file from a drop down list automatically appearing when the user selects the button labeled “Edit Patent Application File”.

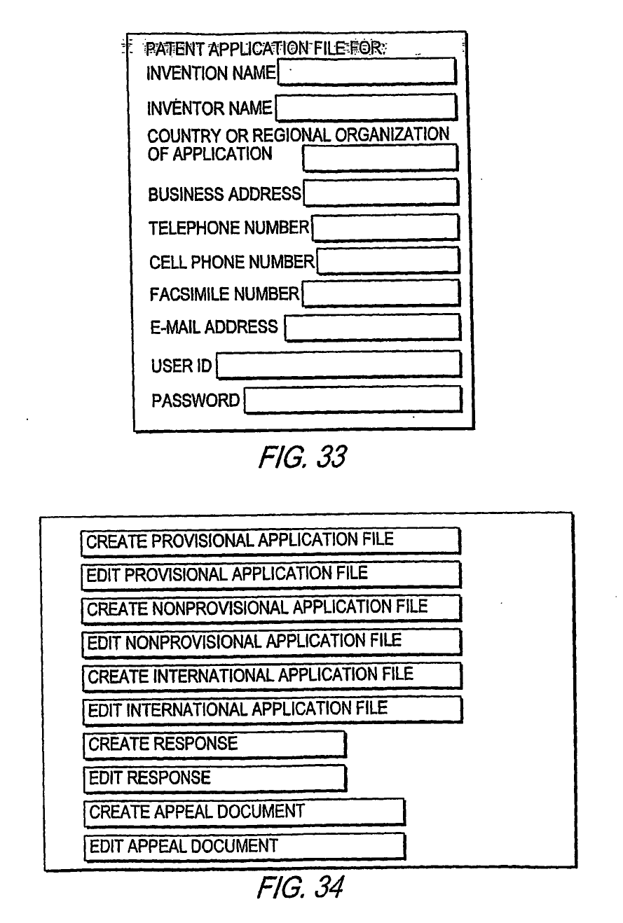

The patent application files will include and be accessed through patent application file interfaces established for each patent application file. A sample interface for a patent application file created by the patent application file module and appearing on a user's personal computer is shown in FIG. 33. The interface indicates the invention name, the inventor's name, the country or regional organization in which the application is being filed, the business address, telephone number, cell phone number, facsimile number, and e-mail address of the inventor, all of which may be entered by the user, or supplied by the patent application module, when available. The cell phone number, facsimile number, and e-mail address of the inventor will preferably be optional information. Each patent application file interface will preferably allow the user to enter a user identification and password for security purposes.

Once a user has satisfied security requirements by, for example, entering a valid user identification and password combination, a further interface will appear (again, assuming a United States filing is selected) prompting the user to create or edit one of three types of patent application files, a provisional application file, a nonprovisional application file, or an international application file under the Patent Cooperation Treaty (PCT), the appropriate type of patent application file being selected by a user, or to create or edit one of two types of patent prosecution documents, a response or an appeal document. To protect the user against mistakenly creating a new file or document of a particular type for a particular invention and country or regional organization where there is already an existing file or document of that type for the particular invention and country or regional organization, the patent application module will display an error message if such an action is attempted. The option to create or edit an international application file will appear no matter what country or regional organization is selected in the exemplary interface shown in FIG. 32B. An exemplary interface providing these options is shown in FIG. 34. Based on the selection by the user of the option in the interface exemplified by FIG. 34, one of three new or existing types of patent application data entry interfaces will appear, namely, a provisional application data entry interface, a nonprovisional application data entry interface, or an international application data entry interface, or one of two new or existing patent prosecution document data entry interfaces will appear, namely, a response data entry interface or an appeal document data entry interface.

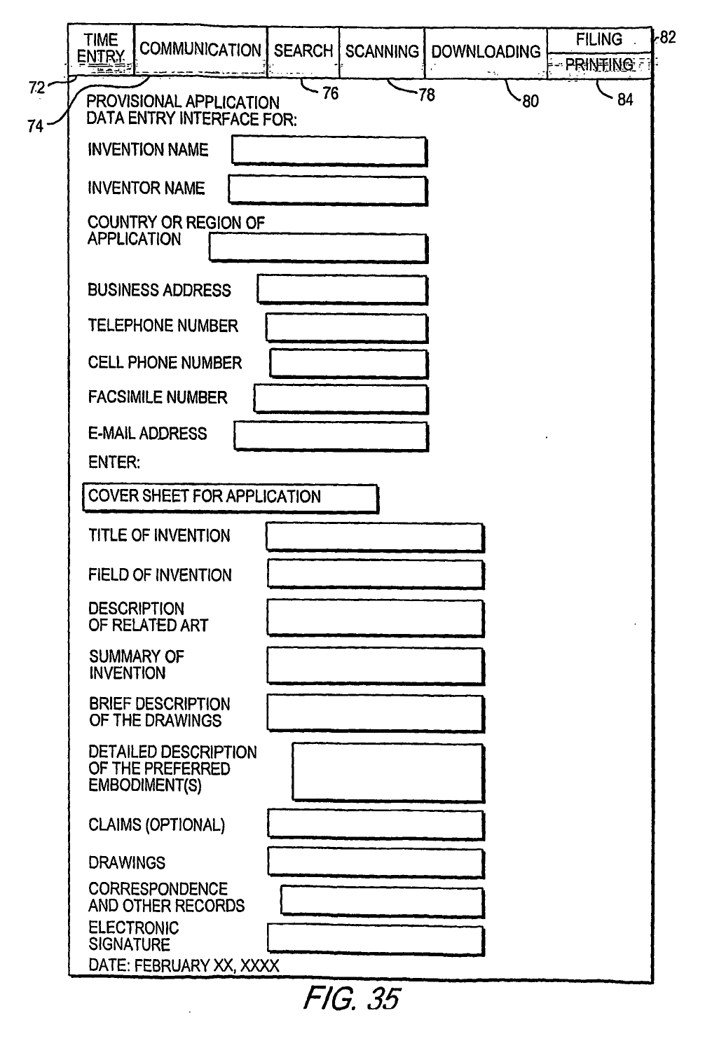

An exemplary provisional application data entry interface is shown in FIG. 35. The provisional application data entry interface has all the data entered in the previously mentioned patent application file interface, except for the user identification and password, such data being automatically copied into it by the patent application module. In addition, the user is required to enter text or scan in documents or drawings for several parts to complete the provisional application. The parts include, for example, Cover Sheet for Application, which upon selecting the button with that label, accesses an electronic copy of the cover sheet for entry of the needed data in the appropriate locations, Title of Invention, Field of the Invention, Description of Related Art, Summary of Invention, Brief Description of the Drawings, Detailed Description of the Preferred Embodiment(s), Claims (optional field), and Drawings. The user is also given the opportunity to enter correspondence and other records, including, but not limited to, documents and drawings, related to the preparation of the application. All entries are made by either manual text entry or by scanning in, for example, documents or drawings. The person making any of the entries on a particular date is required to enter his or her assigned alphanumeric identification string as an electronic signature for verification purposes, and the patent application module will automatically enter the date of the electronic signature. The provisional application data entry interface will also have a toolbar or other menu display allowing the user to select additional functions, such as time entry 72, communication 74, search 76, scanning 78, downloading 80, filing 82, and printing 84, described further below. It should be understood that this provisional application data entry interface assumes the filing of a provisional United States patent application, as previously mentioned. Of course, for regional organizations or other countries, the data entry interface for any provisional type patent application may have different parts than those previously mentioned to complete for such foreign applications.

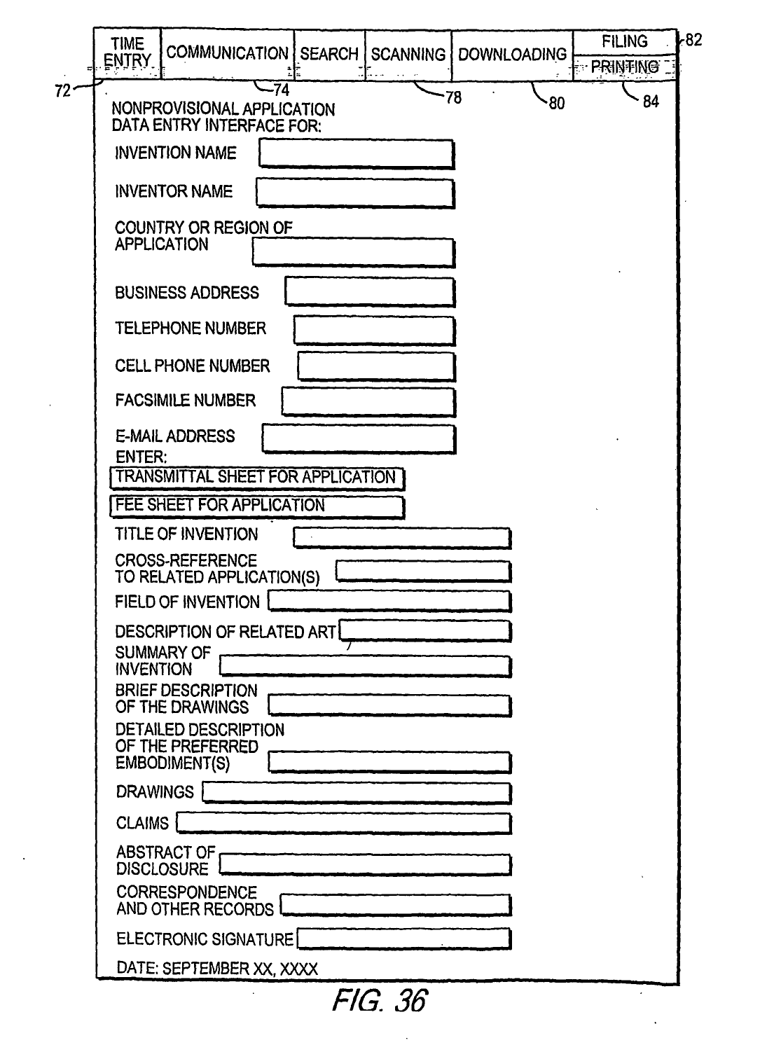

An exemplary nonprovisional application data entry interface is shown in FIG. 36. The nonprovisional application data entry interface has all the data entered in the previously mentioned patent application file interface, except for the user identification and password, such data being automatically copied into it by the patent application module. In addition, the user is required to enter text or scan. in documents or drawings for several parts to complete a nonprovisional application. The parts include, for example, Transmittal Sheet for Application, and Fee Sheet for Application, which upon selecting either of the buttons with those labels, accesses an electronic copy of the appropriate sheet for entry of the needed data in the appropriate locations, Title of Invention, Cross-Reference to Related Application(s), Field of the Invention, Description of Related Art, Summary of Invention, Brief Description of the Drawings, Detailed Description of the Preferred Embodiment(s), Drawings, Claims, and Abstract of the Disclosure. The user is also given the opportunity to enter correspondence and other records, including, but not limited to, documents and drawings, related to the preparation of the application. All entries are made by either manual text entry or by scanning in, for example, documents or drawings. The person making the entries on a particular date is required to enter his or her assigned alphanumeric identification string as an electronic signature for verification purposes, and the patent application module will automatically enter the date of the electronic signature. The nonprovisional application data entry interface will also have a toolbar or other menu display allowing the user to select additional functions, such as time entry 72, communication 74, search 76, scanning 78, downloading 80, filing 82, and printing 84, described further below. It should be understood that this nonprovisional application data entry interface assumes the filing of a nonprovisional United States patent application, as previously mentioned. Of course, for regional organizations or other countries, the data entry interface for any nonprovisional type patent application may have different parts than those previously mentioned to complete for such foreign applications.

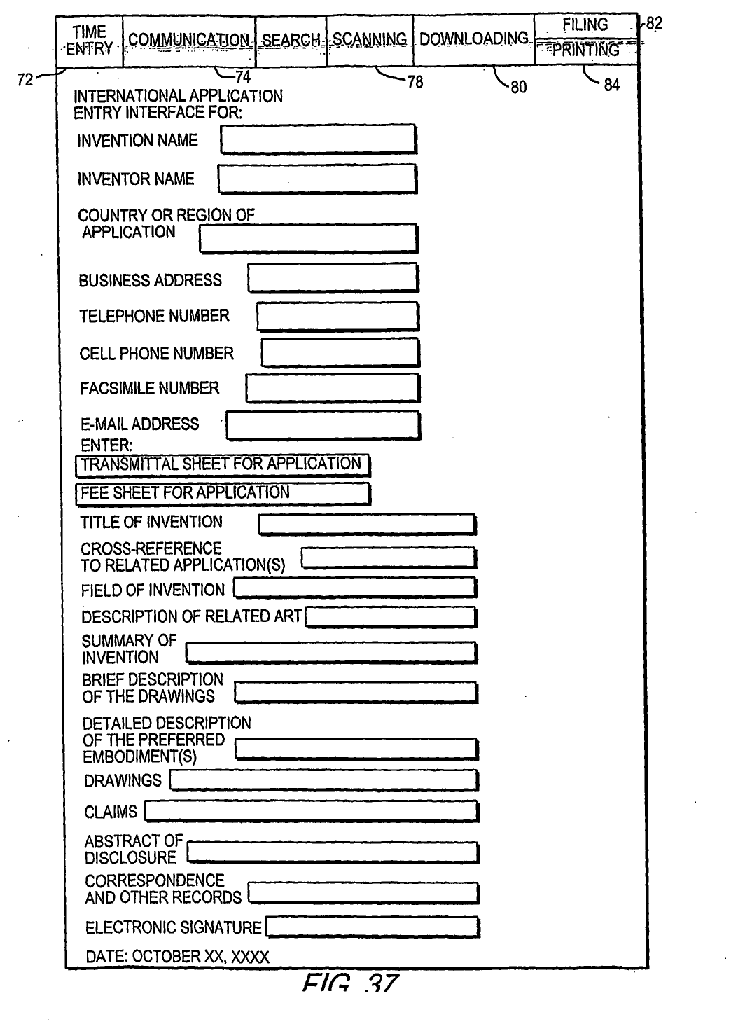

An exemplary international application data entry interface is shown in FIG. 37. The international application data entry interface has all the data entered in the previously mentioned patent application file interface, except for the user identification and password, such data being automatically copied into it by the patent application module. In addition, the user is required to enter text or scan in documents or drawings for several parts to complete an international application. The parts may include, for example, Transmittal Sheet for Application and Fee Sheet for Application, which upon selecting either of the buttons with those labels, accesses an electronic copy of the appropriate sheet for entry of the needed data in the appropriate locations, Title of Invention, Cross-Reference to Related Application(s), Field of the Invention, Description of Related Art, Summary of Invention, Brief Description of the Drawings, Detailed Description of the Preferred Embodiment(s), Drawings, Claims, and Abstract of the Disclosure. The user is also given the opportunity to enter correspondence and other records, including, but not limited to, documents and drawings, related to the preparation of the application. All entries are made by either manual text entry or by scanning in, for example, documents or drawings. The person making the entries on a particular date is required to enter his or her assigned alphanumeric identification string as an electronic signature for verification purposes, and the patent application module will automatically enter the date of the electronic signature. The international application data entry interface will also have a toolbar or other menu display allowing the user to select additional functions, such as time entry 72, communication 74, search 76, scanning 78, downloading 80, filing 82, and printing 84, described further below. This international application data entry interface assumes the filing of an international application in the United States. For filings in regional organizations or other countries, the parts of an international application may differ.

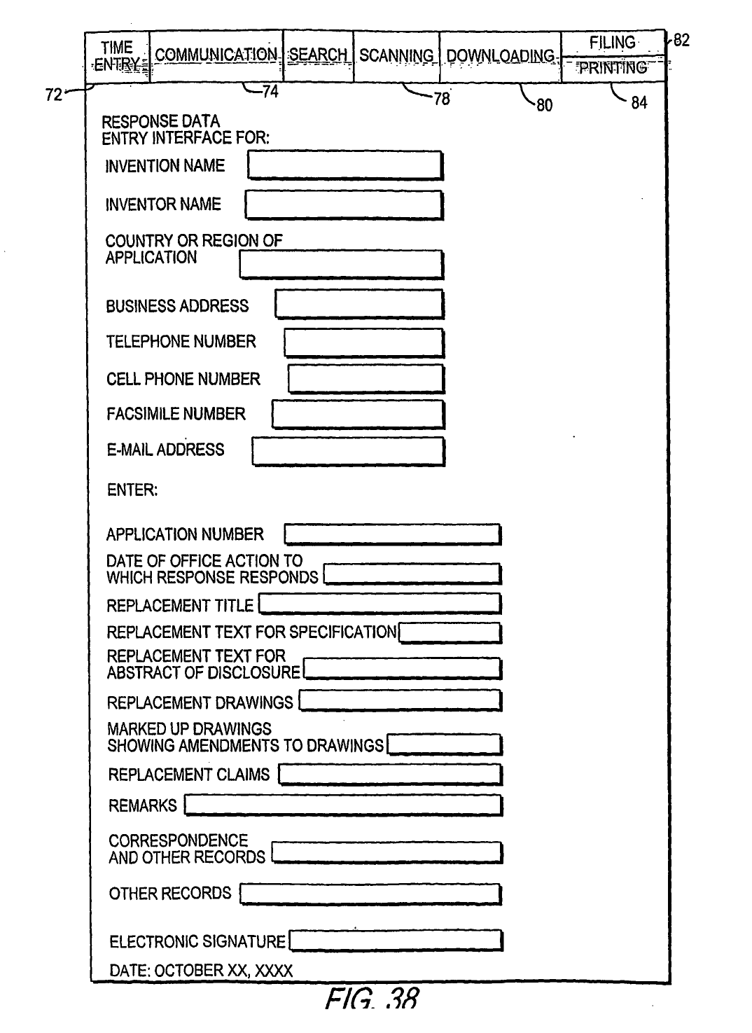

An exemplary response data entry interface is shown in FIG. 38. The response data entry interface has all the data entered in the previously mentioned patent application file interface, except for the user identification and password, such data being automatically copied into it by the patent application module. In addition, the user is required to enter text or scan in documents or drawings for selections from several parts to complete a response. The parts may include, for example, Application Number, Date of Office Action to which Amendment Responds, Replacement Title, Replacement Text for Specification, Replacement Text for Abstract of the Disclosure, Replacement Drawings, Marked Up Drawings Showing Amendments to Drawings, Replacement Claims, and Remarks. The user is also given the opportunity to enter correspondence and other records, including, but not limited to, documents and drawings, related to the response. All entries are made by either manual text entry or by scanning in, for example, documents or drawings. The person making the entries on a particular date is required to enter his or her assigned alphanumeric identification string as an electronic signature for verification purposes, and the patent application module will automatically enter the date of the electronic signature. The response data entry interface will also have a toolbar or other menu display allowing the user to select additional functions, such as time entry 72, communication 74, search 76, scanning 78, downloading 80, filing 82, and printing 84, described further below. This response data entry interface assumes filing of a response in a United States nonprovisional application. For regional organizations or other countries or for international applications, the parts of a response may differ.

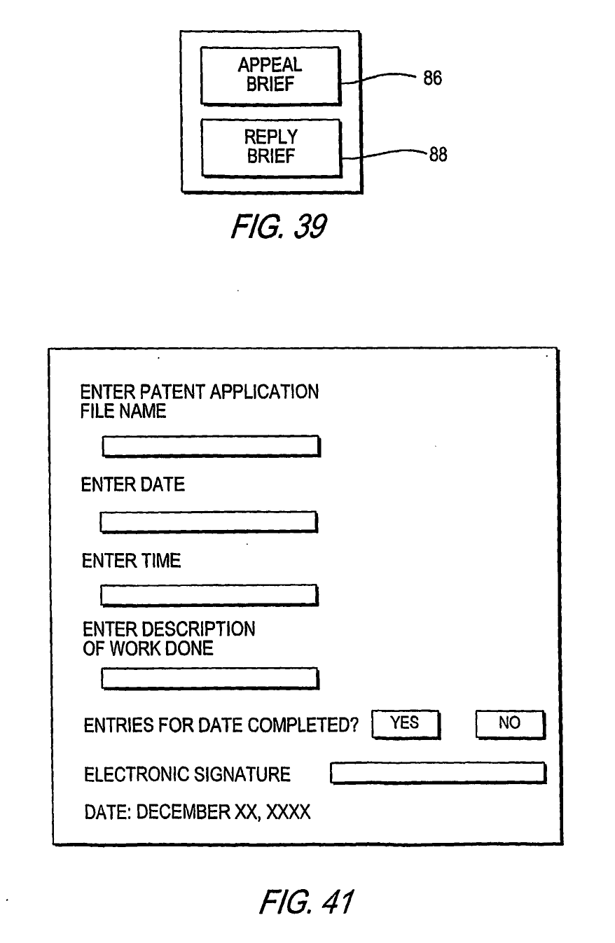

An exemplary appeal document interface is shown in FIG. 39. The user is required to select, for example, Appeal Brief 86 or Reply Brief 88. Upon selecting Appeal Brief, for example, an exemplary Appeal Brief data entry interface, shown in FIG. 40, appears. The Appeal Brief data entry interface has all the data entered in the previously mentioned patent application file interface, except for the user identification and password, such data being automatically copied into it by the patent application module. In addition, the user is required to enter text or scan in documents or drawings for selections from several parts to complete an Appeal Brief. The parts may include, for example, Application Number, Name of Appellant, Name of Appellee, Name of Real Party in Interest, Related Appeals and Interferences, Status of Claims, Status of Amendments, Summary of Invention, Issues, Grouping of Claims, Argument, and Appendix. The user is also given the opportunity to enter correspondence and other records, including, but not limited to, documents and drawings, related to the Appeal Brief. All entries are made by either manual text entry or by scanning in, for example, documents or drawings. The person making the entries on a particular date is required to enter his or her assigned alphanumeric identification string as an electronic signature for verification purposes, and the patent application module will automatically enter the date of the electronic signature. The Appeal Brief data entry interface will also have a toolbar or other menu display allowing the user to select additional functions, such as time entry 72, communication 74, search 76, scanning 78, downloading 80, filing 82, and printing 84, described further below. The appeal document interfaces described above assume filings in the United States, and may differ for filings in regional organizations or other countries. Although interfaces for only two types of patent prosecution documents are described herein, the functionality of the patent application module could be expanded to deal with more uncommon documents such as, for example, petitions, reissue documents, reexamination documents, etc.

The patent application module will also preferably have a time entry function 72 allowing the user to enter the time spent on each patent application file each day and a description of the work done, on a separate screen dedicated for that purpose, shown, for example, in FIG. 41, and covering all patent application files on which work was done. FIG. 41 also requires the user to enter an electronic signature after all of a day's entries have been completed, by, for example, an alphanumeric identification string unique to that user, in order to verify the information entered, and prevent the possibility of fraud. The date of the entry of the electronic signature will automatically be entered by the patent application module.

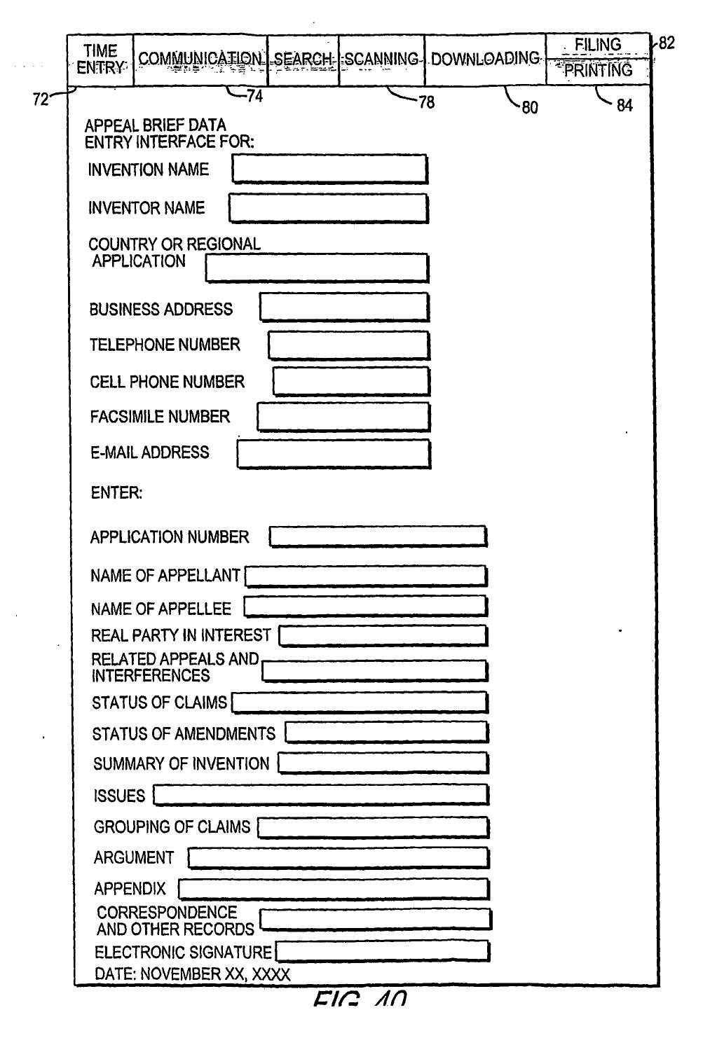

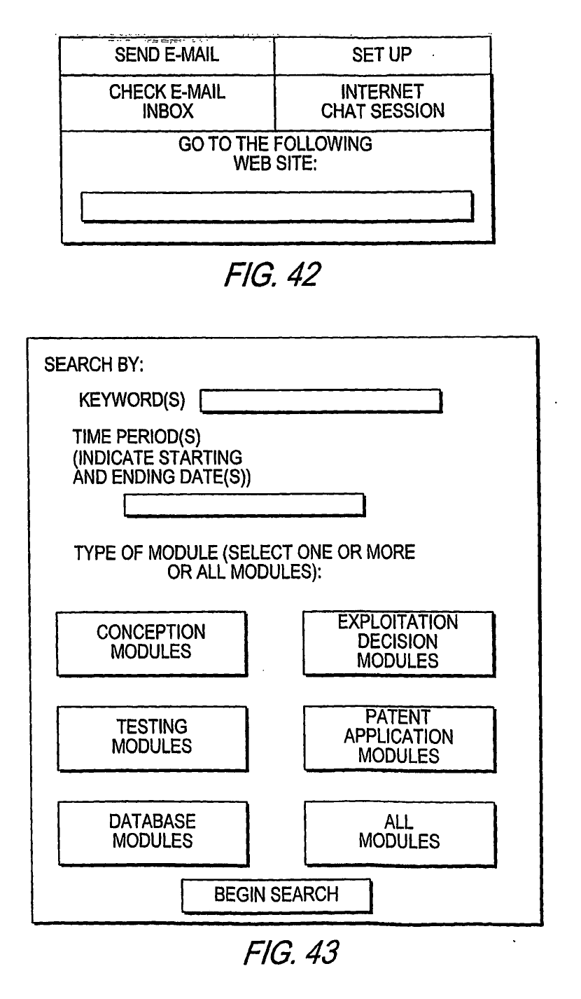

The patent application module should also preferably include a communication function 74, including, for example, an internet browser, e-mail capability, and chat capability. A sample interface for the internet browser, e-mail, and chat functions is shown in FIG. 42. The internet browser may be employed by the user, for example, to search the internet to perform any related art searches desired by the user, the results of which will, preferably, be automatically saved by the patent application module, for later reference by an authorized user. E-mails and internet chat may be used to communicate with other users having the system software, such users being members of the same organization or other organizations, provided security requirements are met, and also other legal personnel in general. Such communication with other users and legal personnel may help to assist and stimulate the process of preparing or prosecuting a patent application or litigating or otherwise participating in post-patent issuance proceedings by, for example, communication about an application between the inventors, the legal department of an organization, and independent law firm(s) retained by an organization on a convenient basis and by such communication about a patent which issued on an application recorded in the system.

Such assistance and stimulation of the inventive process will also be furthered by a preferably included search feature 76 of the patent application module. A sample computer screen showing an interface for such a search feature is shown in FIG. 43. Such a search feature will allow search of information contained within accessible system modules resident on computers in the same organization or in other organizations. Such searches could, for example, be based on key words or other methods well known in the art. Such searches would preferably not include any ability to change or otherwise edit the modules searched. Searches could be limited by time periods or the designation of modules searched, for example.

The search results, if the search is conducted by keyword, could typically indicate each occurrence of the keyword, in a list where each occurrence has the location indicated by a particular project file name, invention file name, exploitation decision file name, testing file name, or patent application file name, as applicable, each file name being a hyperlink, which will take the user to the occurrence of the keyword in the appropriate file upon the user clicking on the file name with a mouse or other input device, for example. The entire file will be available for display, however, to the user upon the user arriving at the location of a keyword which occurs in a particular file. Search results will, preferably, automatically be saved by the patent application module in the particular patent application file in which the search was conducted, and can thereafter be accessed by an authorized user. Search results could assist in and stimulate the inventive process by, for example, indicating a “dead end” to a certain proposed embodiment to be disclosed in an application, promising results or failure encountered by others in the field, the economic impracticability or commercial success of an inventive product, based on marketing or other commercial studies, the failure or success of an embodiment of the invention based on actual testing, or further ideas for follow up investigation.

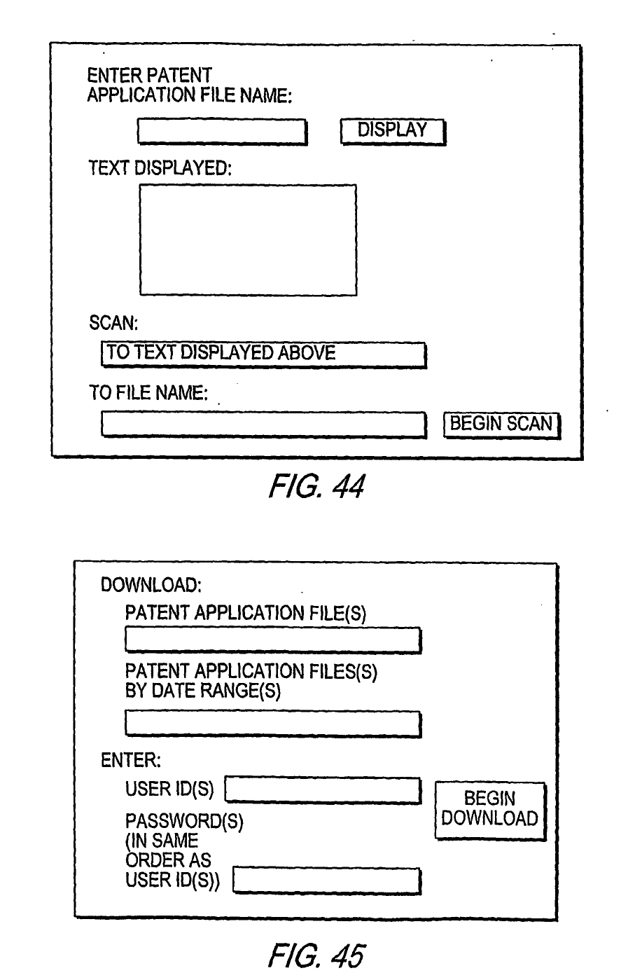

The scanning function 78 of the patent application module preferably possesses a user interface, an exemplary user interface being shown in FIG. 44. The scanning function would, preferably, allow the choice of the scanned image being incorporated in the patent application file being displayed, beginning at the location of the cursor on the computer screen, or would allow a user to create a file, linked to the displayed patent application file, to hold the scanned image. The scanning function would allow the incorporation of relevant documents and drawings into the appropriate file, so as to allow the preparation of as complete an application document as possible.

The downloading function 80 of the patent application module preferably possesses a user interface, an exemplary user interface being shown in FIG. 45. The downloading function would allow the downloading, over the internet or other computer network, of specific patent application files or groups of patent application files with specified date of creation ranges from other copies of the patent application module resident on other computers than the computer from which the download is being performed. The downloading function would be capable of addressing particular patent application modules in an organization or performing the download over all patent application modules in an organization. In order to successfully perform the download, the user would need to know the user identification(s) and password(s) of the user(s) whose patent application modules are the target(s) of the download or the user identification and password of the organization's patent application modules, which are the target of the download, in order to enter them in the download interface. Of course, if the memory available to a patent application module would be exceeded by such a download, the software would display an error message instead of performing the download. Such a function may be of great use to the research and development department, management, and the legal department of the organization or any independent law firm retained by the organization to perform patent work on its behalf. For example, the downloading function can be used to monitor attorney progress as it occurs, allowing management personnel to effectively manage the preparation and prosecution of patent applications, and give the highest priority to those deemed most economically valuable. In addition, the downloading function may be used by both the inventors, and legal personnel to obtain and send drafts and even partially completed drafts of patent documents of all types, both applications and documents prepared during prosecution of applications, in order to more efficiently and effectively prepare such documents, thereby improving the extent and economic value of any patent protection obtained. Furthermore, the downloading function would allow the downloading of specific patent application files or groups of patent application files within specified date of creation ranges from the patent application module resident on a certain computer to a portable drive or other portable memory media for archiving the files, thus releasing the memory on the computer occupied by those files, upon deletion of those files, the patent application module allowing an authorized user to delete any entire patent application file at the discretion of the authorized user.

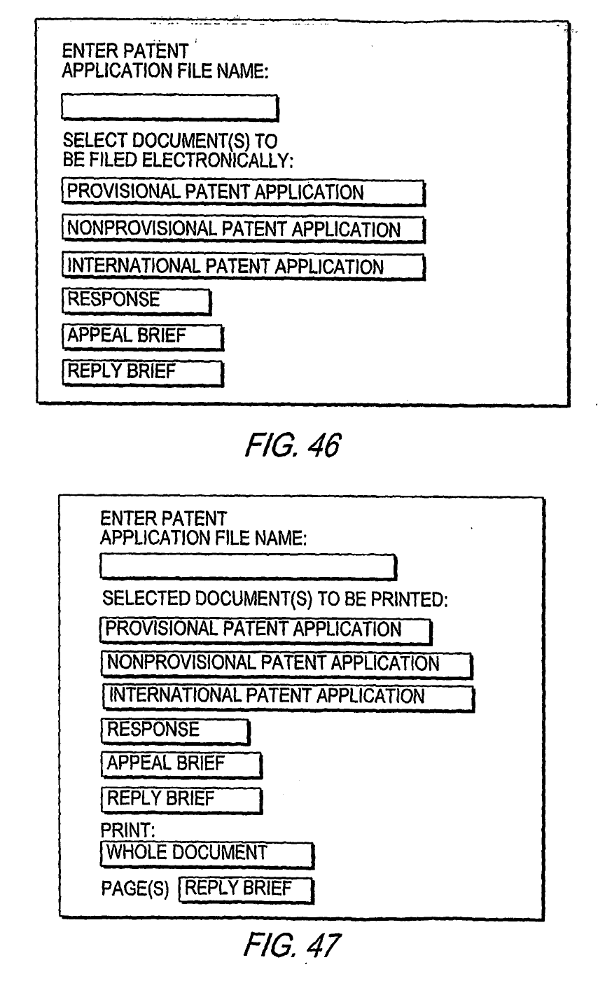

The filing function 82 of the patent application module preferably possesses an interface, as shown in exemplary fashion in FIG. 46, to perform the filing of one or more patent application related documents. The filing function allows the electronic filing of one or more of the selections of patent application related documents, such as a provisional patent application, nonprovisional patent application, international patent application, response, an Appeal Brief, and a Reply Brief, to the extent that electronic filing is possible with the office in which such patent document(s) are to be filed.

An exemplary interface for the printing function 84 of the patent application module is shown in FIG. 47. The printing function allows the printing of one or more patent application related documents either in their entirety for filing purposes, or in part, by, for example, selected pages.

A database module, which is part of the system, stores files which cannot be stored by the other modules originating them because of insufficient available memory. The other modules will automatically send the “overflow files” to the database module(s). Such database module(s) can be installed on computers, where other modules are installed, or may be installed on separate computers or central servers to maximize available memory space. The database module will be designed such that it will automatically produce any file stored therein to the appropriate module for display when a user attempts to access that particular file. The operation of the database module will, preferably, be transparent to the user. In other words, the user will not be aware whether any file displayed is being produced directly by the module being used or whether the file is being supplied from the database module to the module being used.

It should be understood that an attempt to perform any function in any module that requires memory in excess of the available memory will cause an error message to appear advising the user of the insufficient memory condition.

Regarding security arrangements for the software system in general, there should preferably be a method of distributing user identifications and passwords on an organization wide basis, and in controlling types of access, based on such user identifications and passwords, of various parties to various modules of the software system. For example, certain sets of user identifications and passwords could provide access to create new files, delete, and edit existing files within a certain module, others to only create new files and edit existing files, still others to only read files, as in the use of a search function, for example, all access being subject to the existence of any permanent entries, such as the entry of a description of invention in the conception module, as previously mentioned. In addition, various modules may be designated as searchable or not searchable, should users from outside the organization wish to conduct such searches, or alternatively, user identifications and passwords of users from outside the organization may be obtained, and searching access to various modules may be assigned. Furthermore, a user identification and password for the entire organization for each group of the conception modules, exploitation decision modules, testing modules, and patent application modules installed in the organization, should preferably be established for use by users outside the organization in order to download any file in any module, where the download will target all copies of a module resident on computers within the organization. Moreover, unique alphanumeric identification strings should be assigned to each research worker or other authorized user for use as an electronic signature. In addition, although not a security matter, but an administrative matter, the location of any database modules in a computer network serving the organization should be disseminated to all the other modules of the software system installed in the computer network to allow for maximum use of the available memory for file storage. To accomplish these aims, an administrator copy of the software installed in an organization may be distributed to a designated administrator for the software system, with the necessary functionality to establish the above-mentioned security and administrative arrangements. The administrator copy of the software should allow the administrator to change the security and administrative arrangements at any time, subject, again, to the existence of system-designated permanent entries, as previously mentioned.

It should be recognized that entry of data into any of the modules, except for a description of invention entered into an invention file, may be made over many days, and the system will accept such partial entries.

Although in this application one inventor has been assumed, the interfaces should preferably be designed to deal with multiple inventors by the entry of multiple entries in the appropriate places or by the addition of a button labeled, for example, “Add Another Inventor”, which would clear previous entries and allow the addition of new entries.

It should be appreciated from the foregoing disclosure that the similarity of the conception, exploitation decision, testing, and patent application modules in many of their functions, such as communication, search, downloading, and scanning, should lead to their economical design, and a lower overall cost for the system. In addition, the ability of each module to function independently of the others will allow users to add modules as their financial and computing resources allow.

The foregoing disclosure also indicates that the use of the inventive system should lead to better quality patent applications being prepared, to more rapid application preparation, and to more effective patent prosecution than the present methods allow due, for example, to the closer cooperation and more frequent communication between inventors and attorneys made possible by the system, and to the improved availability to attorneys of business and financial information relevant to the invention also made possible by the system.

It can also be foreseen that this system may of great assistance should litigation or any other post-patent issuance proceeding ensue after any patent is obtained on a patent application whose history is recorded therein. To the extent that modules of the system are installed and appropriate entries for such a patent application are made on the various modules, an organized and extensive record of not only the patent prosecution, but of all the phases of the inventive process, even prior to conception, may be afforded those conducting such litigation or any other post-patent issuance proceeding.

It should be understood that, when the term “organization” has been used herein, it can be construed to include individual self-employed inventor(s), where applicable, as well as corporations, whether for profit or non-profit, partnerships, any other private business or non-business organization, and any governmental or quasi-governmental agency or body.

It should be understood that the term “document”, as used herein, should be construed broadly to include any textual matter that can be entered manually or scanned in to form part of an electronic file, including, but not limited to, printed, typewritten, or handwritten text.

It should be understood that the term “drawing”, as used herein, should be construed broadly to include any graphical representation whatsoever, including, but not limited to, blueprints, sketches, other types of drawings than blueprints or sketches, tables, graphs, and charts of any kind.

It should be understood that the conception module, the exploitation decision module, the testing module, and the patent application module all possess a file opening function to display any project file, invention file, exploitation decision file, testing file, patent application file, response file, appeal document file, or any other file stored in their respective modules or in the database module, and a printing function to print any such files or specified pages or selections from such files. The file opening function and the printing function have not been described in more detail above since such functions are commonly available in software of many types and are well known to those with ordinary skill in the art. Further, although each module can be considered to operate independently from any other module, one skilled in the art will appreciate that a single application program can include the functionality of two or more modules. For example, a single module can include the functionality of the conception and test modules.

Finally, although an exemplary description of the invention has been set forth above to enable those of ordinary skill in the art to make and use the invention, that description should not be construed to limit the invention, and various modifications and variations may be made to the description without departing from the scope of the invention, as will be understood by those with ordinary skill in the art. For example, one or more different modules may be substituted for any part of, any, or all of the conception, exploitation decision, testing, patent application, or database modules described herein, while allowing the system for inventive project documentation, management, and stimulation, which is the subject of this application, to continue to function successfully, so long as the modules, which replace any other modules or parts thereof, function with the same results as the modules or parts thereof replaced.

1. A system for use in an inventive process for at least one invention, comprising:
at least one of a conception module, an exploitation module, a testing module, and a patent application module, said conception module adapted to receive, process and communicate information associated with conception and reduction to practice of said at least one invention, said information including information entered at predetermined times by a user of said conception module prior to establishment of an invention file for each of said at least one invention and in response to being prompted by said conception module, said exploitation module adapted to receive, process and communicate information associated with deciding whether to exploit said at least one invention in a market place, said testing module adapted to receive, process and communicate information associated with testing of said at least one invention, and said patent application module adapted to receive, process and communicate information associated with preparation, filing and prosecution of said at least one invention;
each of said modules being adapted for installation and operation with one or more computer devices, and further adapted to share particular information associated with said inventive process with at least another one of said modules, each of said modules, which is installed on a particular computer device, being adapted to search for information in all accessible modules resident on one or more computer devices based on at least one criterion, said information including said information entered at predetermined times by said user of said conception module.

2. The system of claim 1, wherein said conception module is adapted to communicate particular information with said exploitation module, said testing module, and said patent application module, said exploitation module is adapted to communicate particular information with said testing module and said patent application module, and said testing module is adapted to communicate particular information with said patent application module.

3. The system of claim 1, wherein said conception module is adapted to receive commands to create and edit individual files associated with conception and due diligence of said at least one invention.

4. The system of claim 3, wherein said conception module is adapted to generate at least one graphical user interface for receiving said commands and displaying invention development information associated with said at least one invention in response to said commands.

5. The system of claim 1, wherein said conception module is adapted to receive and communicate temporal and progress information associated with development of each invention.

6. The system of claim 5, wherein said progress information includes unexpected results.

7. The system of claim 5, wherein said conception module is adapted to establish an invention file for each invention in response to receiving indication that an invention has been conceived, wherein said invention file includes descriptive and temporal information associated with each invention.

8. The system of claim 1, wherein said exploitation module is adapted to receive commands to create and edit individual files associated with exploiting said at least one invention.

9. The system of claim 8, wherein said exploitation module is adapted to generate at least one graphical user interface for receiving said commands and displaying exploitation information associated with said at least one invention in response to said commands.

10. The system of claim 1, wherein said exploitation module is adapted to receive and communicate temporal and financial information associated with each invention.

11. The system of claim 10, wherein said exploitation module provides sales and revenue forecasts associated with each invention from said financial information.

12. The system of claim 10, wherein said exploitation module is adapted to create an exploitation file for each invention, wherein each exploitation file includes a description of work performed, temporal information associated with said work performed, and a decision regarding exploitation of said invention.

13. The system of claim 1, wherein said testing module is adapted to receive commands to create and edit individual files associated with testing of said at least one invention.

14. The system of claim 13, wherein said testing module is adapted to generate at least one graphical user interface for receiving said commands and displaying test information associated with said at least one invention in response to said commands.

15. The system of claim 1, wherein said testing module is adapted to receive and communicate temporal and test information associated with testing of each invention.

16. The system of claim 14, wherein said test information includes a description of at least one of a process for constructing a prototype device being tested, indicia of a prototype being tested, test processes, expected results, and actual results associated with each test.

17. The system of claim 14, wherein said testing module is adapted to generate a test file including indication that said invention under test is categorized as one of a process, a device, and a composition of matter.

18. The system of claim 1, wherein said patent application module is adapted to receive commands to create and edit individual files associated with preparation, filing and prosecution of patent applications for each invention.

19. The system of claim 18, wherein said patent application module is adapted to generate at least one graphical user interface for receiving said commands and displaying patent application information associated with said at least one invention in response to said commands.

20. The system of claim 1, wherein said patent application module is adapted to receive and communicate information associated with domestic and international types of patent applications.

21. The system of claim 20, wherein said patent application information includes information associated with one or more inventors, a description of the invention, drawings, and claims for each patent application.

22. The system of claim 20, wherein said patent application module is further adapted to receive and communicate information associated with documents that accompany each patent application during filing and prosecution of the application.

23. The system of claim 20, wherein said patent application module is further adapted to receive and communicate information associated with preparation and filing of a response to a patent office communication, an appeal process, and other patent office processes before, during and after issuance of a patent.

24. The system of claim 20, wherein said patent application module is further adapted to correlate patent and patent application relationships.

25. The system of claim 1, wherein each of said modules is adapted to receive electronic signatures for providing authentication and authorization of information.

26. The system of claim 1, wherein each of said modules is adapted to perform searches for specified information associated with said inventive process.

27. The system of claim 1, wherein each of said modules is adapted to facilitate at least one of email and voice communications.

28. The system of claim 1, wherein each of said modules is adapted to facilitate connectivity with other information sources over a public or private network.

29. The system of claim 1, wherein each of said modules is adapted to receive scanned documents and download one or more files.

30. The system of claim 1, further comprising a storage module for storing information associated with said at least one of a conception module, an exploitation module, a testing module, and a patent application module.

31. A method for use in an inventive process for at least one invention, comprising the steps of:
providing at least one computer device having installed thereon at least one of:
a conception module for receiving, processing and communicating information associated with conception and reduction to practice of said at least one invention, said information including information entered at predetermined times by a user of said conception module prior to establishment of an invention file for each of said at least one invention and in response to being prompted by said conception module,
an exploitation module for receiving, processing and communicating information associated with deciding whether to exploit said at least one invention in a market place,
a testing module for receiving, processing and communicating information associated with testing of said at least one invention, and
a patent application module for receiving, processing and communicating information associated with preparation, filing and prosecution of said at least one invention; and
enabling each of said modules to share particular information associated with said inventive process with at least another one of said modules, each of said modules, which is installed on a particular computer device, being adapted to search for information in all accessible modules resident on one or more computer devices based on at least one criterion, said information including said information entered at predetermined times by said user of said conception module.

32. A system including at least one module for use in an inventive process for at least one invention, wherein said at least one module is at least one of a conception module for receiving, processing and communicating information associated with conception and reduction to practice of said at least one invention, said information including information entered at predetermined times by a user of said conception module prior to establishment of an invention file for each of said at least one invention and in response to being prompted by said conception module, an exploitation module for receiving, processing and communicating information associated with deciding whether to exploit said at least one invention in a market place, a testing module for receiving, processing and communicating information associated with testing of said at least one invention, and
a patent application module for receiving, processing and communicating information associated with preparation, filing and prosecution of said at least one invention, each of said modules, which is installed on a particular computer device, being adapted to search for information in all accessible modules resident on one or more computer devices based on at least one criterion, said information including said information entered at predetermined times by said user of said conception module.

33. At least one embodiment of at least one invention, said at least one invention being produced by an inventive process, said inventive process including a method comprising the steps of:
providing at least one computer device having installed thereon at least one of:
a conception module for receiving, processing and communicating information associated with conception and reduction to practice of said at least one invention, said information including information entered at predetermined times by a user of said conception module prior to establishment of an invention file for said at least one invention and in response to being prompted by said conception module,
an exploitation module for receiving, processing and communicating information associated with deciding whether to exploit said at least one invention in a market place,
a testing module for receiving, processing and communicating information associated with testing of said at least one invention, and
a patent application module for receiving, processing and communicating information associated with preparation, filing and prosecution of said at least one invention; and
enabling each of said modules to share particular information associated with said inventive process with at least another one of said modules, each of said modules, which is installed on a particular computer device, being adapted to search for information in all accessible modules resident on one or more computer devices based on at least one criterion, said information including said information entered at predetermined times by said user of said conception module.
